(19) United States
(12) Patent Application Publication
(10) Pub. No.: US 2016/0188742 A1
(43) Pub. Date: Jun. 30, 2016

(54) Bookmarking Search Results

(71) Applicant: Quixey, Inc., Mnoutain View, CA (US)

(72) Inventors: Bennett Ingvoldstad, Mountain View, CA (US); Shravan Sogani, San Ramon, CA (US)

(73) Assignee: Quixey, Inc., Mountain View, CA (US)

(21) Appl. No.: 14/976,804

(22) Filed: Dec. 21, 2015

Related U.S. Application Data
(60) Provisional application No. 62/098,109, filed on Dec. 30, 2014.

(51) Int. Cl. G06F 17/30

(52) U.S. Cl. CPC G06F 17/30884

(57) ABSTRACT

Methods and systems are directed to receiving a user instruction to display a set of bookmarked search results. One or more bookmark result objects can be obtained in response to the user instruction, each bookmark result object respectively corresponding to a previously received search result that a user selected for bookmarking and including one or more parameter values previously entered by a user and reference data to obtain content from a third party resource. For each of the one or more bookmark result objects, the methods and systems are further directed to requesting content from the third party resource using the reference data and the one or more parameter values; receiving the requested content from the third party resource; rendering a bookmarked search result based on the requested content; and outputting the bookmarked search result to a bookmark results page.

### CROSS REFERENCE TO RELATED APPLICATIONS

This U.S. patent application claims priority under 35 U.S.C. §119(e) to U.S. Provisional Application 62/098,109, filed on Dec. 30, 2014, which is hereby incorporated by reference in its entirety.

### TECHNICAL FIELD

This disclosure relates to bookmarking search results.

### BACKGROUND

Search engines can be utilized in many different fields. Search engines can be used to identify content on the World Wide Web (the “Web”), identify applications, or identify functionalities across the Web and a collection of applications. When a search engine receives a search query it provides search results which link to resources. The user can click on a search result to access a resource. For example, the user can click on a search result to access a web page indicated by the search results.

### SUMMARY

One aspect of the disclosure provides a method comprising receiving, by a processing device of a user device, a user instruction to display a set of bookmarked search results. The method further comprises obtaining, by the processing device, one or more bookmark result objects in response to the user instruction, each bookmark result object respectively corresponding to a previously received search result that a user selected for bookmarking and including one or more parameter values previously entered by a user and reference data to obtain content from a third party resource. For each of the one or more bookmark result objects, the method further comprises requesting, by the processing device, content from the third party resource using the reference data and the one or more parameter values; receiving, by the processing device, the requested content from the third party resource; rendering, by the processing device, a bookmarked search result based on the requested content; and outputting, by the processing device, the bookmarked search result to a bookmark results page, the bookmark results page being displayed on a user interface of the user device.

In another example, the disclosure provides a user device comprising a user interface, a storage device, a network interface device, and a processing device. The storage device stores a plurality of bookmark result objects, each bookmark result object respectively corresponding to a previously received search result that a user selected for bookmarking and including reference data to obtain content from a third party resource. The processing device executes computer-readable instructions. The computer readable instructions cause the processing device to receive a user instruction to display a set of bookmarked search results and retrieve one or more of the bookmark result objects in response to the user instruction, wherein at least one of the one or more bookmark result objects include one or more parameter values previously entered by a user. Further, for each of the of the at least one of the one or more bookmark result objects, the computer readable instructions cause the processing device to request content from the third party resource using the reference data and the one or more parameter values, receive the requested content from the third party resource, render a bookmarked search result based on the requested content; and output the bookmarked search result to a bookmark results page, the bookmark results page being displayed on a user interface of the user device.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic illustrating an example environment of a search engine that receives search queries from user devices.

FIG. 1B is a schematic illustrating an example user device in communication with a search engine.

FIG. 1C illustrates an example of a user device displaying search results including a displayed search results that receives user input.

FIG. 1D illustrates an example of a user device executing a native application in response to selection of the displayed search result of FIG. 1C.

FIG. 1E illustrates an example of a user device displaying search results including a displayed search result that receives user input.

FIG. 1F illustrates an example of a user device executing a native application in response to selection of the displayed search result of FIG. 1E.

FIG. 1G illustrates an example of a user device displaying search results including a modifiable displayed search result being displayed in a collapsed viewing mode.

FIG. 1H illustrates an example of a user device displaying search results including a modifiable displayed search result being displayed in an expanded viewing mode.

FIG. 2A is a schematic illustrating example components of a search engine.

FIG. 2B is a schematic illustrating example components of a search engine and data flow thereof.

FIGS. 2C and 2D are schematics illustrating example components of a function record and a result object record, respectively.

FIG. 2E is a schematic illustrating example components of a search module of the search engine and a data flow thereof.

FIG. 2F is a schematic illustrating example data flow of the results processing module.

FIG. 3 is a schematic illustrating example components of a user device.

FIG. 4 is a flow chart illustrating an example set of operations of a method for processing a search query.

FIG. 5 is a flow chart illustrating an example set of operations of a method for performing a search on a user device.

FIG. 6 is a flow chart illustrating an example set of operations of a method for responding to a user selection of a resize element.

FIG. 7 is a flow chart illustrating an example set of operations of a method for accessing a state of an application.

FIG. 8 is a flow chart illustrating an example set of operations of a method for displaying real time data in search results.

FIGS. 9A and 9B illustrate examples of a user device displaying search results.

FIG. 9C illustrates an example of a user device displaying bookmarked search results.

FIG. 9D illustrates an example of a user device displaying bookmarked search results in collapsed and expanded viewing modes.

FIG. 9E is a schematic illustrating an example of a bookmark result object.

FIG. 10 is a flow chart illustrating an example set of operations of a method for bookmarking a displayed search result.

FIG. 11 is a flow chart illustrating an example set of operations of a method for activating bookmarked search results.

Like reference symbols in the various drawings indicate like elements.

### DETAILED DESCRIPTION

Mobile phones and other devices provide access to a variety of applications containing a large amount of content. Users may wish to preview application content before launching and navigating through an application. To this end, devices can present search results that represent (e.g., display information from or about) states and/or functions of applications. For example, a search result may display information about a particular restaurant featured in a restaurant review application. As another example, a search result may display information about nearby taxis that can be booked using a taxi booking application. Such search results may be displayed in a search engine results page (hereinafter “SERP”) of an operating system search function or search application. Therefore, users can find application content without launching an application. Search results may also include links that directly access states of an application without navigating through the application.

Applications may feature static or dynamic states. Static states include content that changes infrequently if at all. One example of a static state is a state of a movie database application describing the actors, director, and plot of a movie. Dynamic states are dependent on a set of parameters, and therefore, may change frequently. For example, a dynamic state of an application may be a state of a restaurants application that lists restaurants that are near the location of a user. As can be appreciated, the list of restaurants that are near the user is dependent on the location of the user and may change as a result of the user changing locations. Accordingly, search results representing application states may contain static and/or dynamic information. Dynamic search results may change based on signals such as time (e.g., movie times at a movie theatre at a particular date), location (e.g., businesses near a location of a user), or context (e.g., products related to a user's recent purchases). Application states may also feature interactive input elements. Correspondingly, search results representing such states may feature interactive input elements. For example, a search result representing a state for booking flights in a travel application may include elements for inputting origin and destination parameters.

Users may wish to bookmark search results from a SERP for several reasons. Bookmarking a search result can refer to an instruction to store information relating to the search result for later viewing by the user. Bookmarked search results can allow a user to easily refer back to previously viewed application content, and enable users to quickly return to a particular application state via links to that state. Moreover, bookmarked dynamic search results may dynamically update as application content changes, allowing users to easily monitor a particular application state. Additionally or alternatively, bookmarked interactive search results may save a particular set of parameters in order to avoid making the user repeatedly input the same parameters to reach a desired state. In order to bookmark search results, methods and systems for finding and displaying search results, storing search results data (including parameter data) for later access, updating dynamic search results content, and adjusting links based on input elements are presented herein.

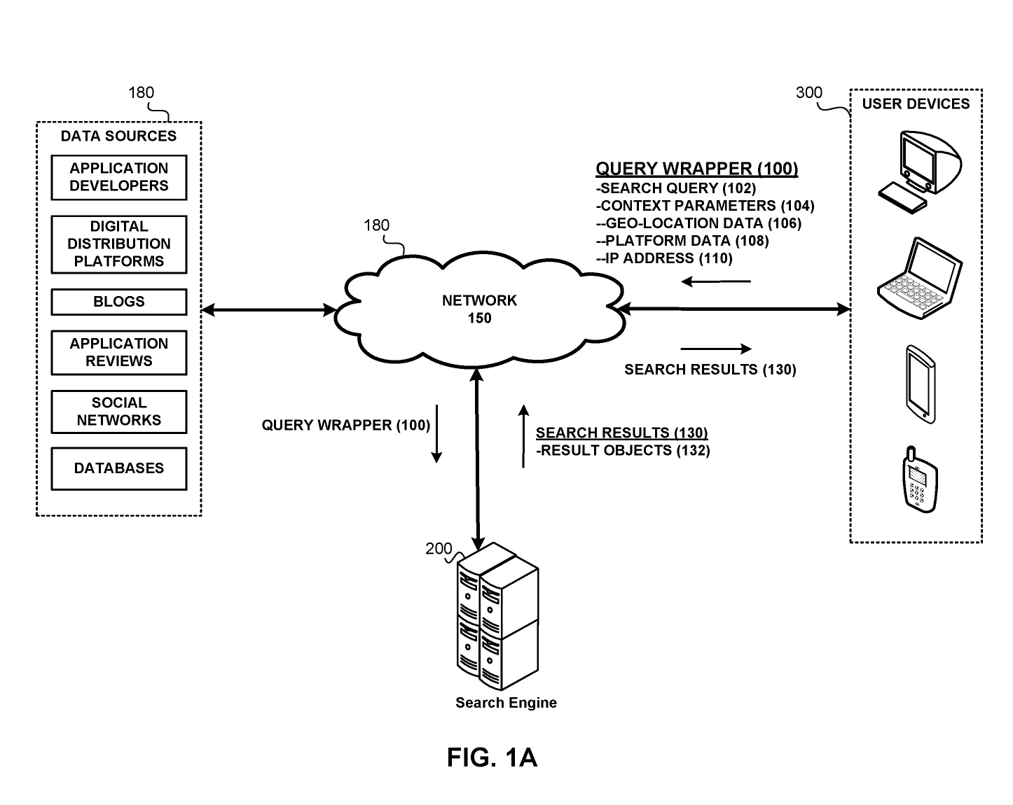

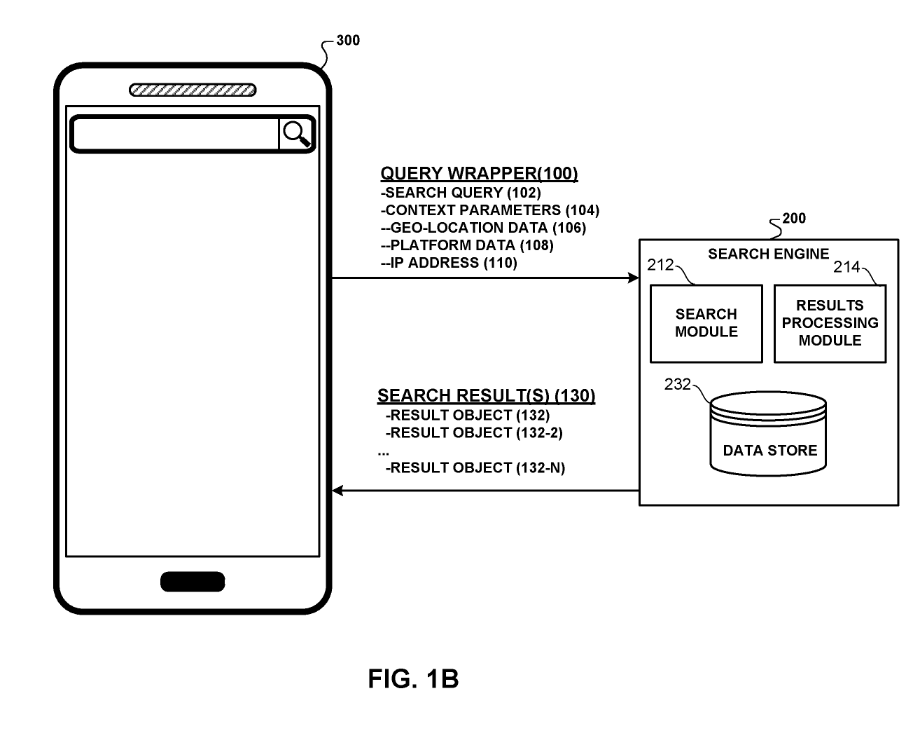

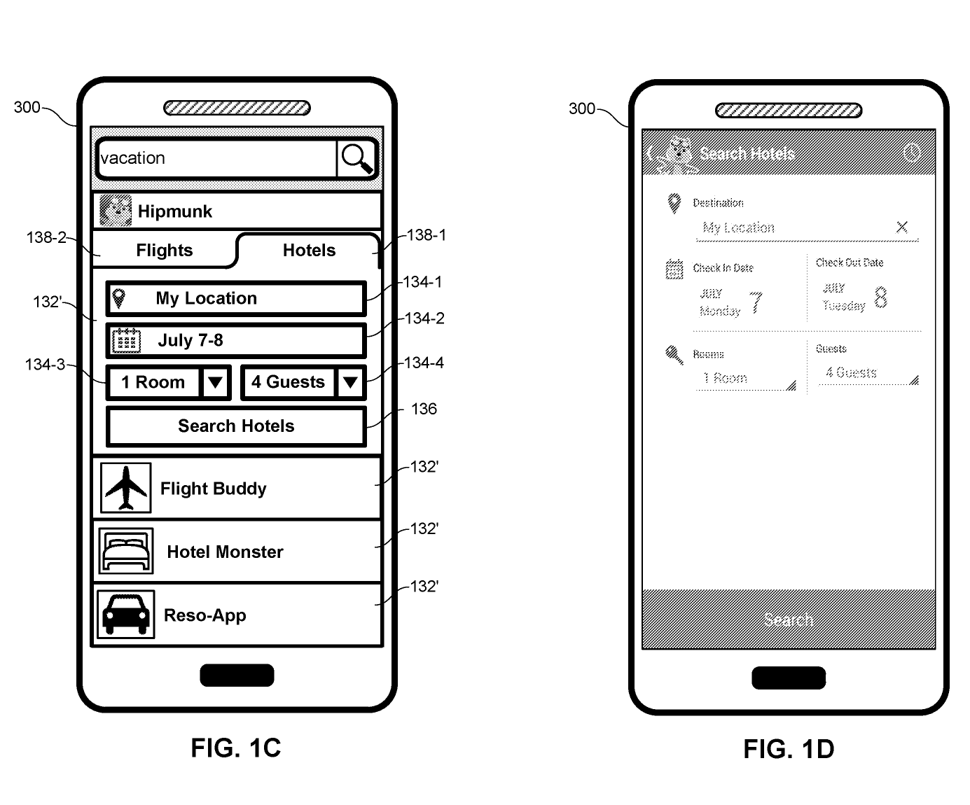

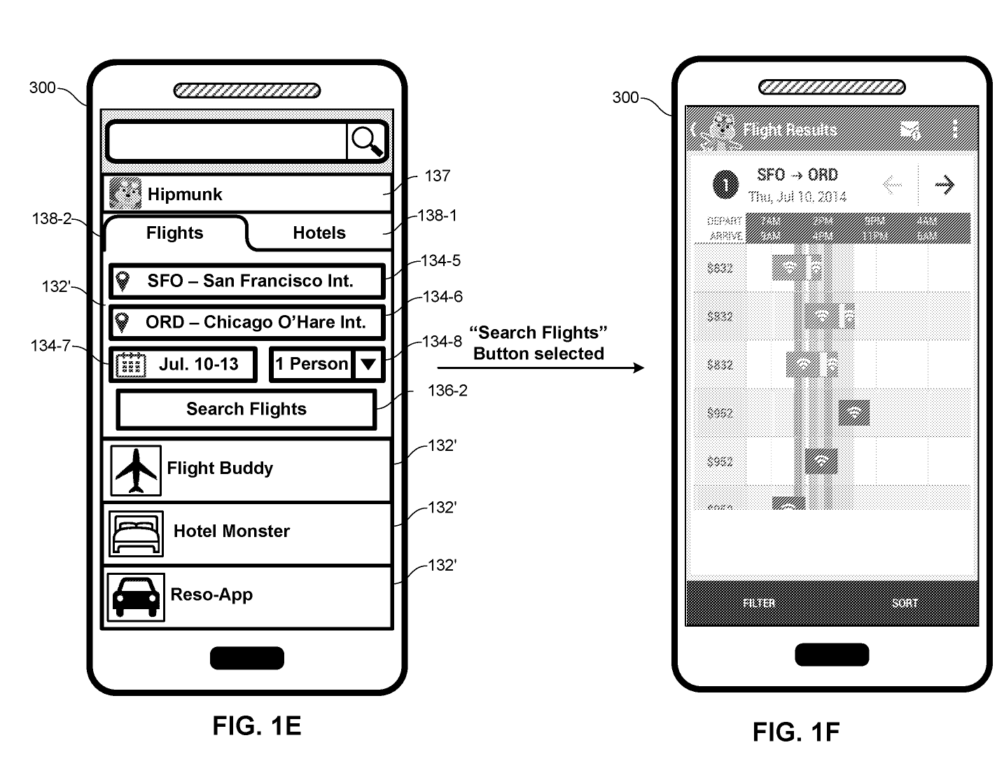

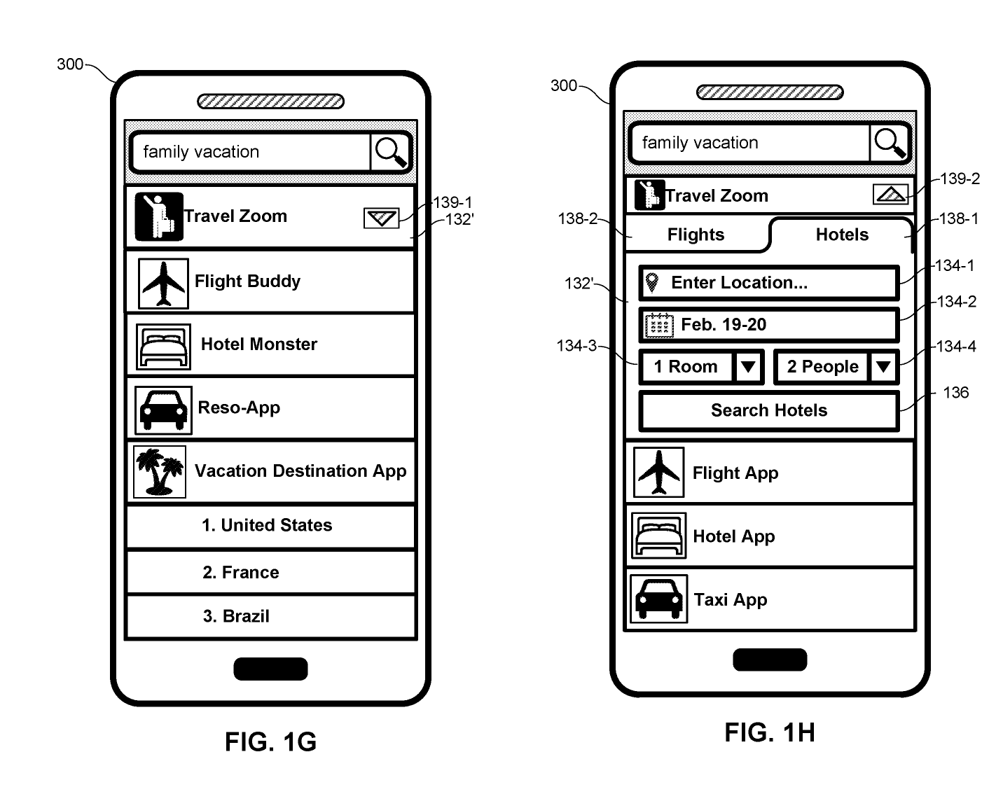

FIG. 1A illustrates an example environment 10 of a search engine 200. A search engine 200 is a collection of one or more computing devices that receives search queries 102 from user devices 300 via a network 150. A user device 300 can be any suitable user computing device including, but not limited to, a smartphone 300-1, a tablet computing device 300-2, a personal computing device 300-3, a laptop computing device 300-4, a gaming device, a vehicle infotainment device, and/or a smart appliance (e.g., smart refrigerator or smart television).

The search engine 200 may perform any suitable type of searches. For example, the search engine 200 may perform web searches (e.g., for content found on websites), application searches (e.g., for applications having particular attributes), and/or function searches (e.g., for specific states or functions of either native or web applications). For purposes of explanation, reference is made to a search engine 200 that performs function searches, whereby the search engine 200 identifies states or functions of applications that are relevant to the search query 102. The search engine 200 may perform other types of searches, while performing the function searches and the search results 130 may indicate the results of the other searches as well.

An application can refer to a software product that, when executed by a computing device, causes the computing device to perform a function. In some examples, an application may also be referred to as an “app” or a “program.” Example applications include, but are not limited to, productivity applications, social media applications, messaging applications, media streaming applications, social networking applications, and games. Applications can perform a variety of different functions for a user. For example, a restaurant reservation application can make reservations for restaurants. As another example, an internet media player application can stream media (e.g., a song or movie) from the Internet. In some examples, a single application can provide more than one function. For example, a restaurant reservation application may also allow a user to retrieve information about a restaurant and read user reviews for the restaurant in addition to making reservations. As another example, an internet media player application may also allow a user to perform searches for digital media, purchase digital media, generate media playlists, and share media playlists. Applications can include native applications and web-based applications.

A native application is an application that is, at least in part, installed on a user device 300. In some scenarios, a native application is installed on a user device 300, but accesses an external resource (e.g., an application server) to obtain data from the external resource. For example, social media applications, weather applications, news applications, and search applications may respectively include one or more native application versions that execute on various user devices 300. In such examples, a native application can provide data to and/or receive data from the external resource while performing one or more functions of the application. In other scenarios, a native application is installed on the user device 300 and does not access any external resources. For example, some gaming applications, calendar applications, media player applications, and document viewing applications may not require a connection to a network to perform a particular function.

A web-based application (also referred to herein as a web application) may be partially executed by a user device 300 (e.g., by a web browser executed by the user device 300) and partially executed by a remote computing device (e.g., a web server or application server). For example, a web application may be an application that is executed, at least in part, by a web server and accessed by a web browser (e.g., a native application) of the user device 300. Example web applications may include, but are not limited to, web-based email, online auctions websites, social-networking websites, travel booking websites, and online retail websites.

In some scenarios, an application includes one or more native application editions of the application and a web application edition of the application. In these scenarios, there may be overlap between the states or functions that the native application edition(s) can access and the states or functions that the web application edition can access. For example, a restaurant review application may have reviews of thousands of restaurants and may also provide an on-line ordering function from some of the restaurants. The restaurant review application may have a first native application edition configured for a first operating system (e.g., the ANDROID operating system maintained by Google, Inc.), a second native application edition configured for a second operating system (e.g., the IOS operating system developed by Apple, Inc.), and a web application edition accessible using a web browser. The restaurant review application may allow all the editions (native and web) to access the various reviews of restaurants but may only allow on-line orders to be placed using the native application editions. In this way, some states or functions of the restaurant review application cannot be accessed by the web application edition but there is overlap between the states or functions that can be accessed by the native application editions and the web application edition.

In general, the user device 300 may communicate with the search engine 200 using any application that can transmit search queries 102 to the search engine 200. In some examples, the user device 300 runs a native application that is dedicated to interfacing with the search engine 200 (e.g., a search application 312). In some examples, the user device 300 communicates with the search engine 200 using a more general application, such as a web application accessed using a web browser native application. Although the user device 300 may communicate with the search engine 200 using the native search application 312 and/or a web-browser application, the user device 300 may be described hereinafter as using the native search application 312 to communicate with the search engine 200. In some implementations, the functionality attributed to the search application 312 may be included as a searching component of a larger application that has additional functionality. For example, the functionality attributed to the search application 312 may be included as part of a native application or a web application as a feature of another application that provides search capabilities.

A user device 300 transmits a search query 102 to the search engine 200, which processes the search query 102 and generates search results 130 based thereon. A search query 102 can refer to a set of one or more query terms. A query term is a string of one or more characters (e.g., letters, number, and/or symbols). In some implementations, the user device 300 transmits the search query 102 in a query wrapper 100. A query wrapper 100 is a transmittable data structure that stores the search query 102. The query wrapper 100 can contain additional information, which may be referred to as context parameters 104. Examples of context parameters 104 include geolocation data 106 that indicates a geolocation of the user device 300 at a particular time, platform data 108 that indicates an operating system type of the user device 300, an IP address 110 that indicates an IP address of the user device 300, and any other suitable data (e.g., a username of a user associated with the user device 300).

The search engine 200 generates search results 130 based on a search query 102 (and in some cases one or more context parameters 104) and provides the search results 130 to a requesting user device 300. According to some implementations, the search engine 200 identifies one or more states or functions of one or more respective applications that are relevant to the search query 102. For instance, in response to the search query 102 “call a cab,” the search engine 200 identifies various states or functions of applications that can help a user make a taxi reservation.

The search engine 200 generates search results 130 that are indicative of the identified states or functions. The user device 300 renders the search results 130 into displayed search results 132′. The search results 130 can include one or more result objects 132. In some implementations, each result object 132 represents a single search result 132. A result object 132 can include an encoded search result, which can define search result data (e.g., text, images, and instructions). In some implementations, a result object includes data and instructions which the user device 300 utilizes to render the displayed search result 132′. The data and instructions may define the layout of displayed search result 132′ as well as the look and feel of the displayed search result (e.g., fonts, font sizes, styles, colors, etc.). The user device 300 renders a displayed search result 132′ using the search result data defined by the encoded search result. For purposes of explanation, reference to a “search result” can include reference to an encoded search result or a displayed search result 132′. Put another way, before a search result has been rendered, the term “search result” references an encoded search result, and after rendering references a displayed search result resulting from the encoded search result.

A result object 132 can include any suitable search result data. For example, a result object 132 can include display data, access mechanism data, GUI data, instructions, referential data, a result score, and layout data. A result object 132 may include any combination of the above-identified data, as well as additional or alternative data. The individual types of data that may be found in a result object 132 are described in greater detail below.

A displayed search result 132′ can link a user to a state of an application. In these implementations, the displayed search results 132′ are a collection of user selectable links, whereby the user selectable links link the user to one of a plurality of applications or a state (or function) thereof that are relevant to the search query 102. A user selectable link can include one or more access mechanisms. Examples of access mechanisms include, but are not limited to, native application access mechanisms (hereinafter “application access mechanism”), web access mechanisms, application download access mechanisms, and/or scripts. A user device 300 uses an access mechanism to access functionality of an application. An access mechanism can provide access to a default page of an application (e.g., a home page) or a deeper state of the application.

An application access mechanism may be a string that includes a reference to a native application (e.g., one of native applications) and indicates one or more operations for the user device 300 to perform. If a user selects a user selectable link 144 including an application access mechanism, the user device 300 may launch the native application referenced in the application access mechanism and perform the one or more operations indicated in the application access mechanism. In some implementations, any combination of the operating system of the user device 300, a search application executed by the user device 300, a native application executed by the user device 300, and/or a web browser executed by the user device 300 can launch the native application referenced in the application access mechanism A web access mechanism may include a resource identifier that includes a reference to a web resource (e.g., a page of a web application/website). For example, a web access mechanism may refer to a uniform resource locator (URL) (i.e., a web address) used with hypertext transfer protocol (HTTP). If a user selects a user selectable link including a web access mechanism, the user device 300 may launch the web browser application and retrieve the web resource indicated in the resource identifier. An application download access mechanism may indicate a location (e.g., a digital distribution platform) where a native application can be downloaded in the scenario where a native application edition of the application is not installed on the user device 300. If a user selects a user selectable link 144 including an application download access mechanism, the user device 300 may access a digital distribution platform from which the referenced native application edition may be downloaded. A script is a set of instructions, that when executed by the user device 300 cause the user device to access a resource indicated by the script. For example, the script may instruct an operating system of the user device 300 to launch the native application, and may define one or more additional instructions to access a particular state of the application. A script may be used instead of another type of access mechanism when an application is not configured to be referenced by the other types of access mechanisms.

In some scenarios, the search results 130 include result objects 132 that define one or more input elements. An input element can refer to a GUI element that receives input from a user via the user interface of the user device 300, whereby the value entered into an input element maps to one of a set of input parameters. When the user device 300 renders and displays a displayed search result 132′, the displayed search result 132′ can receive and display the value in an area of the displayed result 132′ defined by the input element. Examples of input elements can include, but are not limited to, text input element, drop-down menus, calendar input elements, radio button input elements, and slider input elements. When the user enters one or more values into respective input elements of a displayed search result 132′ and selects the displayed search result 132′ (e.g., presses an execution element), the user device 300 accesses a state of an application indicated by the search result that is based on the one or more values. In this way, the displayed search result 132′ is a user selectable link that receives input from a user. In some implementations, the user device 300 utilizes an access mechanism that is indicative of the one or more values to access the state of the application indicated by the displayed search result 132′. The user device 300 can receive, request, and/or generate the access mechanism, examples of which are displayed in greater detail below.

FIG. 1C illustrates an example of displayed search results 132′. In some scenarios, the search engine 200 responds to a search query 102 with search results 130, that when rendered by the user device 300, include one or more displayed search results 132′ that include one or more input elements 134. In the illustrated example, the displayed search results 132′ are in response to the search query 102 “vacation.” The displayed search results 132′ include a displayed search result 132′-1 that allows the user to access a hotel booking functionality of the HIPMUNK application by Hipmunk, Inc. In this example, the example displayed search result 132′-1 includes a text input element 134-1 that allows the user to enter a location, a calendar input element 134-2 that allows the user to enter check-in and check-out dates, a first drop-down menu input element 134-3 that allows the user to select a number of rooms, and a second drop-down menu input element 134-4 that allows the user to select a number of guests. The user can input various values into the respective input elements and select (e.g., press upon) a selection box 136-1, thereby selecting the displayed search result 132′-1.

In response to the user selection of the displayed search result 132′-1, the user device 300 launches the HIPMUNK application and provides the values inputted into the input elements to the HIPMUNK application. As will be discussed, the user device 300 can provide the values to an application in a number of different manners. For example, the user device 300 can utilize an access mechanism that is based on the values entered into the displayed search result 132′-1 to access a state of the HIPMUNK application that is based on the inputted values. Additionally or alternatively, the user device 300 can launch a native application edition (or a web-application edition) of the HIPMUNK application and can enter the values inputted by the user into a graphical user interface displayed by the native application. In FIG. 1D, the user device 300 has launched, and is executing, the HIPMUNK application in response to the user selecting the displayed search result 132′-1 displayed in FIG. 1C. In this example, the user device 300 enters the values provided by the user into the displayed search result 132-1 of FIG. 1C into the graphical user interface of the HIPMUNK native application. In this way, selection of the displayed search result 132-1 allows the user to access the hotel reservation function of the HIPMUNK application.

In some scenarios, a displayed search result 132′ can link to multiple functionalities of an application. FIG. 1E (and FIG. 1C) illustrates an example of a displayed search result 132′-1 that can link to multiple functionalities of an application. In this example, the user has selected the flight tab 138-2 to link to the flight reservation function of the HIPMUNK application instead of the hotel reservation function of the HIPMUNK application. In the illustrated example, the flight tab includes first and second input elements 134-5, 134-6 that respectively allow a user to enter a departure airport and an arrival airport. The flight tab 138-2 of the displayed search result 132-1 further includes a calendar input element 134-7 that allows a user to enter departure and return dates, as well as a drop down menu 134-8 that allows the user to enter a number of travelers. The user can access the flight reservation functionality of the HIPMUNK application by selecting the “search flights” selection element 136-2.

In FIG. 1F, the user device 300 has launched the native application edition of the HIPMUNK application and has accessed a state of the HIMPUNK application that displays available flight options given the values input by the user into the displayed search result 132-1. In this example, the user device 300 may have utilized an application access mechanism that is based on the inputted values to access the state of the HIPMUNK application. In this way, the user device 300 is able to directly access this state from the SERP based on the values entered into the input elements 134 of the displayed search result 132′. The user device 300 may obtain the application access mechanism in a number of different manners. For example, the user device 300 may request the application access mechanism from the search engine 200 upon user selection of the selection element 136 or may generate the application access mechanism based on the inputted values. In another example, the user device 300 may utilize a set of instructions for generating access mechanisms for a particular application given a set of parameter types. In other implementations, the user device 300 can behave in a manner similar to the examples of FIGS. 1C and 1D, whereby the user device 300 launches the application and inputs the parameters into a GUI of the native application.

Referring now to FIGS. 1G and 1H, one issue that arises with mobile user devices 300 (e.g., tablets and smartphones) is that screen space is limited. Thus, in some implementations, one or more of the displayed search results 132′ can be viewed in two or more viewing modes. For example, a displayed search result 132′ can be displayed in a collapsed viewing mode and in an expanded viewing mode. In these implementations, a displayed search result 132′ that can be viewed in different modes (e.g., collapsed and expanded) may include a resize element 139. A resize element 139 is a GUI element that when selected by a user, causes the displayed search result 132′ to toggle to another viewing mode. For example, selection of the resize element 139 when the displayed search result 132′ is presented in collapsed viewing mode (e.g., FIG. 1G), may cause the user device 300 to toggle the displayed search result 132′ to an expanded viewing mode. Similarly, when a displayed search result 132′ is presented in an expanded viewing mode (e.g., FIG. 1H), selection of the resize element 139 causes the displayed search result 132′ to toggle to a collapsed viewing mode.

A collapsed viewing mode can refer to a mode where a displayed search result 132′ imparts a limited amount of data. For example, in a collapsed viewing mode, the displayed search result 132′ may display a name of the application and a resize element 132. Furthermore, in the collapsed viewing mode, the displayed search result 132′ may include a limited amount of text (e.g., a brief description of the application). In the example of FIG. 1G, the displayed search result 132′-2 corresponding to an example application called “Travel Zoom” is displayed in a collapsed viewing mode. In the illustrated example, the displayed search result 132′-2 presents a limited amount of information (e.g., an application name) and a resize element 139. In some implementations, the displayed search result 132′-2 may act as a user selectable link, whereby when the user selects the displayed search result 132′-2 in the collapsed viewing result, the user device 300 launches the Travel Zoom application (e.g., native or web) to a default state (e.g., a home screen). In other implementations, the displayed search result 132′-2 must be expanded in order for the displayed search result 132′-2 in order to link to the indicated application.

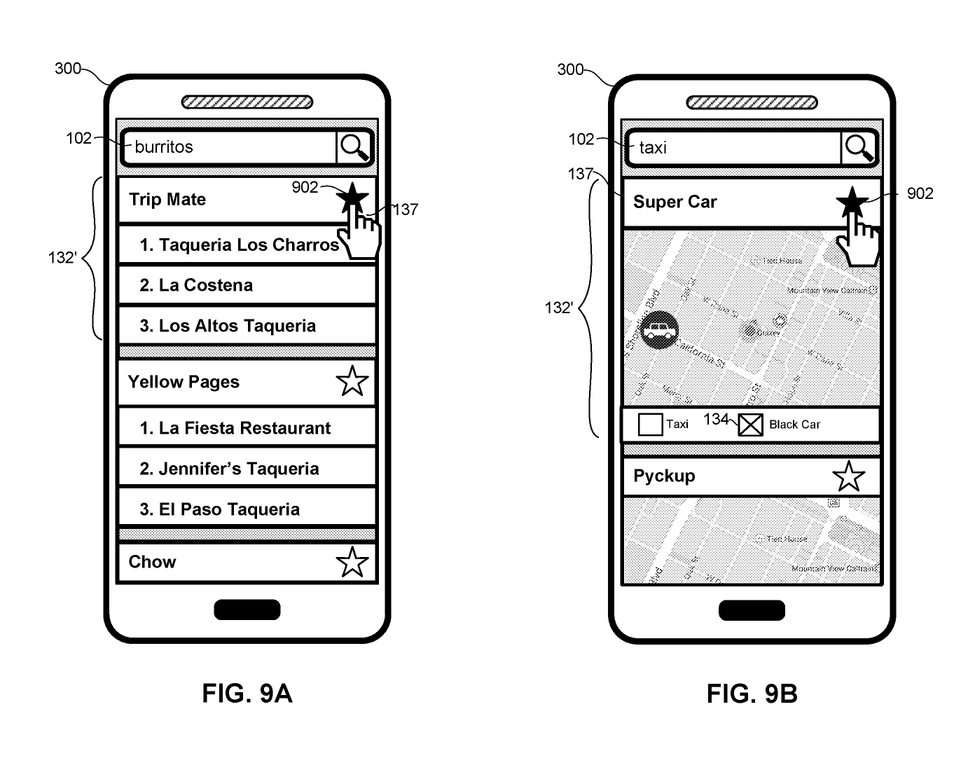

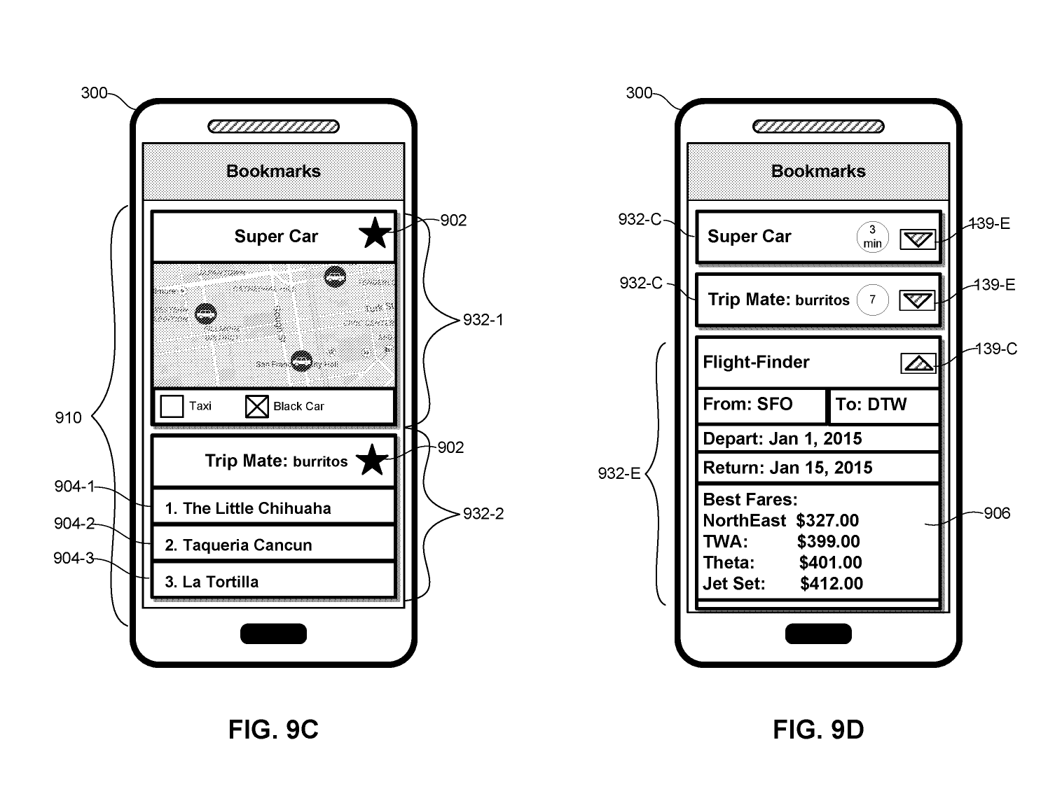

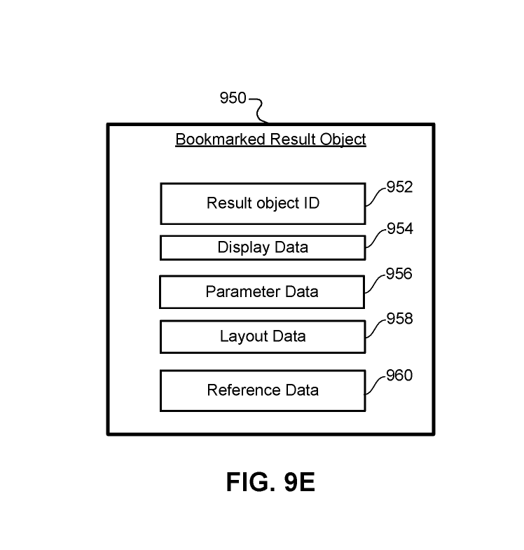

When the user selects the resize element 139-1, the user device 300 toggles the displayed search result 132-2 to an expanded viewing mode (e.g., FIG. 1H). An expanded viewing mode can refer to a mode where the displayed search result 132′ provides additional information or functionality. In an expanded viewing mode, the displayed search result 132′ can include input elements 134, as well as more information, such as a description of an application, a rating of the application, a description of a state of an application, or any other suitable information. Furthermore, in an expanded viewing mode, a displayed search result 132′ can include two or more tabs, as was discussed above. In the example of FIG. 1H, the displayed search result 132-2 corresponding to the Travel Zoom application is displayed in an expanded viewing mode. In this example, the displayed search result 132′-2 includes multiple input elements 134 that allow the user to enter values corresponding to various input parameters (e.g., location, check-in/checkout dates, number of rooms, and number of guests). The user can enter values into the respective input elements 134 and select the selection element 136 to launch the Travel Zoom application to a state corresponding to the inputted values, as was described with respect to FIGS. 1C-1F. Furthermore, the displayed search result 132-2 includes a resize element 139-2. When in an expanded mode, selection of the resize element 139-2 causes the user device 300 to toggle the displayed search result 132′-2 into a different viewing mode (e.g., collapsed viewing mode of FIG. 1G). In some implementations, an expanded displayed search result 132′ includes a header section 137 (see, e.g., FIGS. 9A and 9B). In these implementations, the header 137 may be a user selectable link to a default state of the application. For example, selection of the Travel Zoom header 137 can cause the user device 300 to launch the Travel Zoom application to a default state (e.g., a home screen of the Travel Zoom application).

In some implementations, a displayed search result 132′ may further display real-time data. Real-time data can refer to information that is apt to change (i.e., dynamic data). For example, a restaurant reservation application may have a user interface that allows a user to select from a plurality of different available reservation times for a restaurant. In such an example, the available restaurant times may be viewable in an expanded viewing mode, but not in a collapsed viewing mode. Initially, the displayed search result 132′ may be displayed in a collapsed viewing mode. When the user selects a resize element 139 to expand the displayed search result 132′ into an expanded viewing mode, the user device 300 can request the data from an external resource (e.g., the search engine 200 or a server affiliated with the restaurant reservation application). In this way, the user device 300 does not receive the real-time data unless the user wishes to view the real-time data.

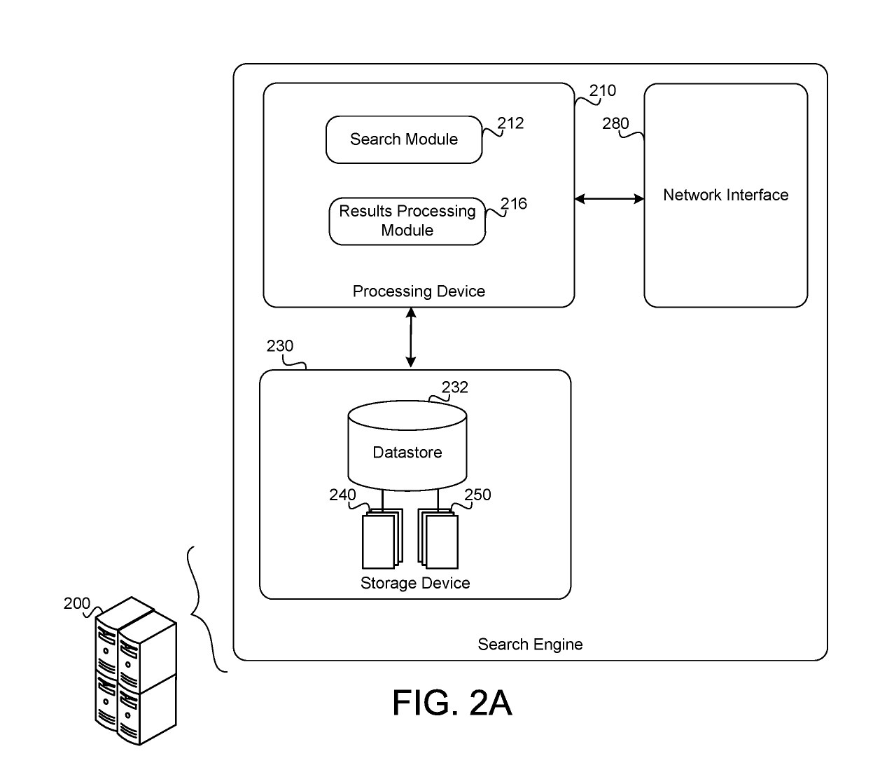

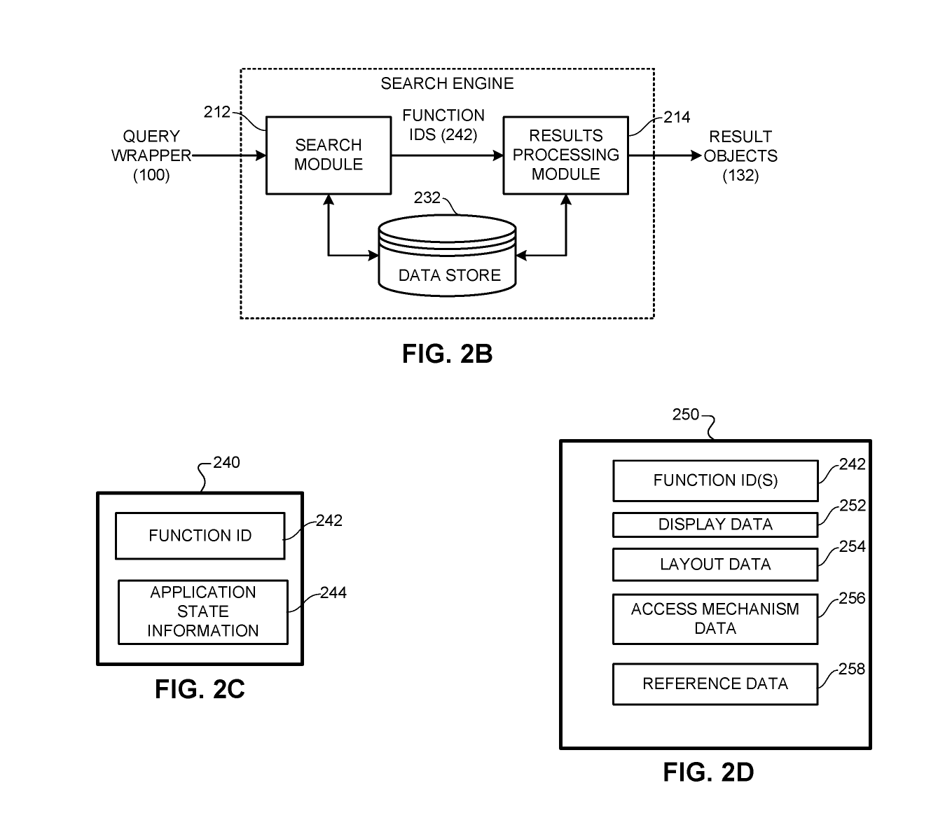

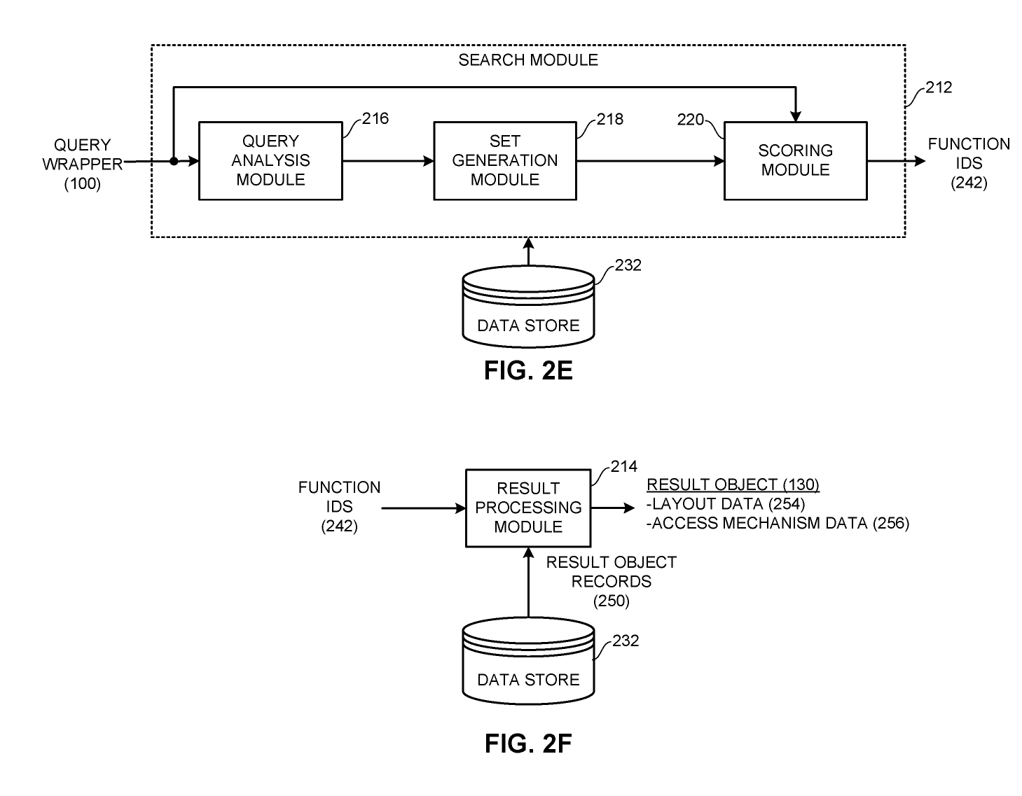

FIGS. 2A-2F illustrate an example search engine 200 and data flows thereof. In the illustrated example of FIG. 2A, the search engine 200 includes, but is not limited to a processing device 210, a storage device 230, and a network interface device 280. In some implementations, the search engine 200 may be incorporated in a larger search system (not shown) that includes an advertising engine and/or other engines. For purposes of discussion, the search engine 200 is described as performing functional searches. Although the techniques described herein may be applied to other suitable searches.

The processing device 210 can include memory (e.g., RAM and/or ROM) that stores computer executable instructions and one or more processors that execute the computer executable instructions. In implementations of two or more processors, the processors can operate in an individual or distributed manner. In these implementations, the processors can be arranged in a single computing device or across multiple computing devices (e.g., rack-mounted servers). The processing device 210 can execute a search module 212 and a results processing module 214.

The network interface device 280 includes one or more devices that can perform wired or wireless (e.g., Wi-Fi or cellular) communication. Examples of the network interface device 280 include, but are not limited to, a transceiver configured to perform communications using the IEEE 802.11 wireless standard, an Ethernet port, a wireless transmitter, and a universal serial bus (USB) port.

The storage device 230 can include one or more computer readable storage mediums (e.g., hard disk drives and/or flash memory drives). The storage mediums can be located at the same physical location or at different physical locations (e.g., different servers and/or different data centers). In the illustrated example, the storage device 230 stores a data store 232. The data store 232 may include one or more databases, indices (e.g., inverted indices), tables, files, or other data structures which may be used to implement the techniques of the present disclosure. The data store stores function records 240 and result object records 250. While reference is made to a single data store 232, the function records 240 and result object records 250 may be stored in separate data stores 232. The storage device 230 may store any other suitable data stores.

FIG. 2B illustrates an example data flow of the search engine 200 according to some implementations of the present disclosure. In the illustrated example, the search module 212 receives a query wrapper 100 that contains a search query 102. The search module 212 searches the function records 240 stored in the data store 232 to identify a set of function records 240 that are relevant to the search query 102. The search module 212 scores the function records 240, and outputs a set of scored function identifiers 242 to the results processing module 214. The scored function IDs 242 respectively represent the scored function records 240. Additionally or alternatively, the search module 212 can be configured to output actual function records 240.

FIG. 2C illustrates an example of a function record 240. Each function record 240 may include data related to a function of an application and/or the state of the application resulting from performance of the function. A function record 240 may include a function identifier 242 (referred to as a “function ID”) and application state information 244. The function records 240 can contain additional types of data not explicitly discussed without departing from the score of the disclosure.

A function ID 242 can identify a function record 240 among the other function records 240 included in the function record data store 232. The function ID 242 may be a string of alphabetic, numeric, and/or symbolic characters. In some examples, the function ID 242 may describe a function and/or an application state in human readable form. For example, the function ID 242 may include the name of the application referenced in the function record 240. Additionally, or alternatively, the function ID 242 may be a human readable string that describes a function performed by the function or state corresponding to the function record 240. In some examples, the function ID 242 may include a string in the format of or similar to a uniform resource locator (URL) of a web access mechanism. For example, the function ID 242 may be a web URL or a URL-like structure that references a different namespace (e.g., “func://” instead of “http://”).

In a specific example, if the function record 240 corresponds to a function of an application, “XYZ,” the function ID 242 may include the name “XYZ” along with a description of the application state described in the application state information 244. For example, the function ID 242 for a function record that describes and provides reviews of a restaurant named “The French Connection,” may be “XYZ—The French Connection.” In an example where the function ID 242 includes a string in the format of a URL, the function ID 242 may include the following string “http://www.xyz.com/biz/the-french-connection-2?ob=1” to uniquely identify the function record 240. In other examples, the function ID 242 may include a URL using a namespace other than “http://,” such as “func://,” which may indicate that the URL is being used as a function ID 242 in a function record 240 (e.g., “func://xyz.com/biz/the-french-connection-2?ob=1”).

The application state information 244 may include data that describes features of a state or functionality to which the function record 240 corresponds. The application state information 244 may include a variety of different types of data. The application state information 244 may include structured, semi-structured, and/or unstructured data. In some implementations, the search engine 200 may extract and/or infer the application state information 244 from documents retrieved from various data sources. For example, the search engine 200 may crawl various data sources 180 (FIG. 1A) such as digital distribution platforms, websites of application developers, reviews of applications, the applications themselves (native applications and/or web applications), and any other suitable data sources 180 to obtain the application state information 244. Additionally or alternatively, the application state information 244 may be human curated. In some examples, the application state information 244 may include data that an application presents to a user when the application is set to an application state defined by an access mechanism. For example, if the function record 240 is associated with a shopping application, the application state information 244 may include data that describes a product (e.g., product name, product seller, product description, and prices) that are shown when the shopping application is set to a particular state application state. As another example, if the function record 240 is associated with a music player application, the application state information 244 may include data that describes a song (e.g., name of the song, album of the song, artist, reviews of the song, etc.) that is played when the music player application is set to a particular application state. Furthermore, the application state information 244 may include information that describes the application itself. For example, the application state information 244 may include a name of the application, a developer of the application, and the platforms for which the application is developed (e.g., web-based, IOS, ANDROID, FIRE OS, etc.).

In some scenarios, the application state information 244 describes features of a function of the application when set to a particular state. In some implementations, the application state information 244 can include a description of the function. Put another way, the application state information can define a broad action, synonyms of the broad action, and terms that may be associated with the broad action. For example, if a function record 240 corresponds to a flight reservation functionality, the application state information 244 may include “make flight reservations” as a broad action, synonyms of the broad action (e.g., “buy plane tickets,” “search flights,” etc.), and terms or phrases associated typically associated with the broad action (e.g., “flights,” “vacation,” “travel to,” airport codes, city names, country names, etc.). In another example, a function records 240 corresponding to a restaurant searching functionality of an application may include a broad action “find a restaurant,” synonyms of the broad action (e.g., “search restaurants,” “find food,” etc.), and terms associated with the broad action (e.g., restaurant cuisines, city names, etc.).

The types of data included in the application state information 244 may depend on the type of information associated with the application state and the functionality of the application. In one example, if the function record 240 is for an application that provides reviews of restaurants, the application state information 244 may include information (e.g., text and numbers) related to a restaurant, such as a name of the restaurant, a category of the restaurant, actual reviews of the restaurant, ratings of the restaurant, an address of the restaurant, hours of operation of the restaurant, and a menu for the restaurant. As another example, if the function record 240 is for an application that plays music, the application state information 244 may include information related to a song, such as the name of the song, the artist, lyrics, and listener reviews and/or ratings. In some implementations, such data may be structured in predetermined fields to help facilitate the generation of result objects 132 that are transmitted in the search results 130.

In some implementations, the application state information 244 further includes what parameter types, if any, the application receives at a given state or when performing a particular function. For instance, if an application state corresponds to a travel application's flight booking functionality, the application state information 244 may include the following parameter types: a Boolean round trip parameter, a departure location (geolocation or a string designating an airport code), an arrival location (geolocation or a string designating an airport code), a departure date, a return date, an integer indicating a number of passengers, and a seat type (e.g., business class, first class, economy). In another example, if an application state corresponds to creating a calendar event functionality, the application state information 244 may include the following parameter types: a string indicating an event name, a time parameter indicating a start time, a time parameter indicating an end time, a string indicating guests or invitees, and a frequency parameter that indicates the days or dates to which the calendar event pertains (e.g., Monday thru Friday, the first of every month, etc.).

Referring back to FIG. 2B, the search module 212 identifies a consideration set of function records 240 based on the search query 102 (and possibly one or more context parameters), as well as the features described in the application state information 244 of the function records 240 stored in the data store 232. The search module 212 determines a result score for each function record 240 in the consideration set. In some implementations, the search module 212 associates the result score of a function record 240 with the function ID 242 of the function record 240. In this way, the search module 212 generates a set of scored function IDs 242. The search module 212 outputs the scored function IDs 242 to the results processing module 214. It is noted that the search module 212 may additionally or alternatively output scored function records 240 to the results processing module 214, which can include the function IDs 242 of the output records.

The results processing module 214 receives the scored function IDs 242 and generates search results 130 based thereon. In some implementations, the results processing module 214 identifies one or more function IDs 242 to base a result object 132 on based on the result score. The results processing module 214 accesses the result object records 250 stored in the data store 232 to generate the result objects 132.

FIG. 2D illustrates an example result object record 250 according to some implementations of the present disclosure. In the illustrated example, a result object record 250 can store one or more function IDs 242, display data 252, layout data 254, access mechanism data 256, and reference data 258. The result object record 250 can contain additional types of data not explicitly discussed without departing from the score of the disclosure.

The one or more function IDs 242 indicate the function records 240 to which the result object record 250 corresponds. In the instance that multiple function IDs 242 are stored in the result object record 250, then the result object records 250 can be used to generate result objects 132 corresponding to multiple function records 240. For example, if a particular result object record 250 can be used to generate result objects 132 for different states of an application (e.g., reviews of different restaurants), the function IDs 242 of the function records 240 describing the different states can be included in the particular result object record 250.

Display data 252 can include text data and image data. The text data can include any text to be included in a displayed search result 132′. For example, the text data can include, but is not limited to, a title of an application, a description of an application, a description of an application function or state, text describing how the application is relevant to the search query, and a rating of an application. The image data can include any images to be included in a displayed search result 132′. For example, the image data can include, but is not limited to, an application icon that represents the application, user interface images used for rendering the displayed search result 132′ (e.g., images such as screenshots). Image data may also include animations and videos.

Access mechanism data 256 can include any suitable information relating to the one or more access mechanisms that the results processing module 214 includes in a result object 132. In some implementations, the access mechanism data 256 includes the access mechanisms that correspond to a function ID 242 or function record 240. Put another way, the access mechanism data 256 can include one or more access mechanisms to access a particular state of an application. In some implementations, the access mechanism data 256 can include instructions for generating access mechanisms to access one or more states of an application. For example, the access mechanism data 256 can include templates for generating an application resource identifier and/or web resource identifiers. Each template can define a namespace corresponding to an application to be accessed and a manner by which to arrange one or more values within the resource identifier given the parameter type of each value. For example, a template for accessing a flight miles calculator of a native application called “MilesCalculator” may be of the form: “MilesCalculator:://[airport_code_2].[airport_code_2].roundtrip=[t/f]. In this example, the template takes in three parameters, a first airport code, a second airport code, and a Boolean flag indicating whether the trip is a round trip. In this way, an application access mechanism to access the flight miles calculator functionality of the “MilesCalculator” native application can be generated using the template, given a first airport code, a second airport code, and a designation of whether the flight is one-way or round-trip. In another example, the access mechanism data can include templates that define operations for accessing a state or function of an application. For example, the templates can define a manner by which to generate a script to access a native application, and potentially to input one or more parameter values to the native application. Drawing from the “MilesCalculator” example, the template may include operations that cause the operating system to launch the MilesCalculator, and operations that cause the operating system to input a first airport code, a second airport code, and a Boolean flag indicating whether the flight is a round-trip to the MilesCalculator application. The latter operations may include parameter fields that receive the values that are either provided into the search query 102 and/or input into a displayed search result 132′ by a user. In this way, a script to access a particular functionality of an application given a set of parameter values may be generated either by the search engine 200 or a user device 300. In particular, the user device 300 can transmit the inputted parameters back to the search engine 200 and the search engine 200 can generate the script or the search engine 200 can provide the instructions and/or template for generating the script with the search results 130, whereby the user device 300 utilizes the instructions and/or template to generate the script.

Layout data 254 includes any suitable data that the user device 300 utilizes to render displayed search result 132′. Layout data 254 can include data that defines the “look and feel” of a displayed search result 132′. The layout data 254 may define the types of elements that appear in a displayed search result 132′ and where each element appears in a displayed search result 132′. For instance, the layout data 254 may define where an images (e.g., icons or screen shots of an application) appear in a displayed search result 132′, where text may appear in the displayed search result 132′, where input elements 134 may appear in the displayed search result 132′, where selection elements 136 may appear in a displayed search result 132′, where tabs 138 are displayed in a displayed search result 132′, and/or where a resize element 139 appears in a displayed search result 132′. Further, the layout data 254 may define other visual features of a displayed search result 132′. For example, the layout data 254 may define the font and font size of text, the text to be displayed in certain elements (e.g., text to be displayed on input elements 134, selection elements 136, and tabs 138. Furthermore, in implementations where a displayed search result 132′ can be collapsible, the layout data 254 can define the look and feel of the displayed search result 132′ when it is in a collapsed viewing mode and when it is in an expanded viewing mode. Put another way, the layout data 254 can define the layout of the displayed search result 132′ when in the collapsed viewing mode and the layout of the displayed search results 132′ when in the expanded viewing mode.

The layout data 254 defines the input elements 134 that can be included in a displayed search result 132′ as well as tabs 138 and resize elements 139. Examples of input elements 134 include pop-out windows, text input elements, menus, calendars, check boxes, radio buttons, slider bars. A pop-out window is a GUI element that is presented in the foreground of the SERP, leaving the previous interface in the background such that the pop-out window is overlaying the background. A pop-out window can display text and/or images, and may also include other input elements or other GUI elements. A text input element is an input element that allows a user to manually enter text. A menu is an input element 134 that allows a user to select from a predefined list of choices. In some examples, a menu may be presented as a menu bar. Additionally or alternatively, a menu may include sub-menus such that when an item in the menu is selected, a sub-menu is presented to the user. Calendars are input elements 134 that allow a user to enter one or more dates. In some implementations, calendars include pop-out windows that display a calendar where the user can select specific dates. Additionally or alternatively, a calendar may be implemented as one or more drop-down menus. Check boxes, radio buttons, and slider bars, are input elements that allow a user to toggle between two different input values (e.g., two different Boolean values). For example, check boxes, radio buttons, and/or slider buttons may prompt a user to select between one of two options (e.g., round-trip or one-way, male or female, yes or no, true or false, etc.).

The layout data 254 may further define other elements that can be displayed in a displayed search result 132′, such as link data, grid data, and tab data. Link data can refer to data and instructions that cause the displayed search result 132′ (or a portion thereof) to behave as a user selectable link. The link data can define text or images that are rendered in the displayed search result 132′. The link data may further reference the access mechanism data 256 such that when a user selectable link is selected, the user device 300 displaying the search result 132′ accesses the resource based on the access mechanism data 256. In some scenarios, the link data may define a selection element 136. Grid data can define the dimensions of a grid that is displayed in a displayed search result 132′. In this way, a displayed search result 132′ may present information in a tabular format (e.g., a spreadsheet), whereby a user may be allowed to edit one or more of the values presented in the grid. Tab data can define data that allows a user to navigate between two or more different tabs of a displayed search result 132′. Tab data can include names of the tabs, as well as can define the particular elements contained in each tab.

The layout data 254 may include input bindings that assign parameter types (e.g., variable names) to the input elements, such that when a user inputs a value into the input element 134, the user device 300 can assign the entered value to a particular parameter value. For example, if a displayed search result 132′ includes a text input element that receives values corresponding to a departure airport and the user enters a three letter airport code, the binding assigns the three letter airport code to a parameter that represents the departure airport. In this way, the user device 300 can use the inputted values to request or generate access mechanisms.

The layout data 254 may further include output bindings. An output binding maps values (e.g., an application name, application description, a state name, an application icon, etc.) to various elements of the displayed search result 132′. For example, an element within a displayed search result 132′ may display a name of a state, and the display data 252 may define a name of a particular state or application. In this example, the binding may bind the defined name of the state to the element that displays the names of a state, such that when rendered, the displayed search result 132′ outputs the name of the state or application.

In some implementations, the layout data 254 may be encoded in a layout file. A layout file can contain a layout object and one or more bindings. The layout file defines the layout of a displayed search result. For example, the layout file can define where each element is located within a displayed search result, the fonts used in each element, the size of each element, and/or the data types of each element. The one or more bindings can include an input binding and an output binding. In this way, content may be presented in a displayed search result 132′ and information may be received via the displayed search result 132′ in accordance with the layout file. In some implementations, a layout file is provided by an application developer. In these implementations, the application developer can develop custom-made search results. For example, an application developer can decide how displayed search results 132′ linking to states of its application appear to a user.

In some implementations, a layout file may be referenced by a layout identifier (layout ID). A layout ID can be a string made up of characters, numbers, and/or symbols that uniquely identify a layout file. In these implementations, a layout file may be stored at the search engine 200, a third party resource, or at the individual user devices 300 and referenced using the layout ID. In implementations where layout files are stored at the individual user devices 300, a result object 132 can include a layout ID and the user device 300 can retrieve the layout file corresponding to the layout ID and render the displayed search result 132′ based on content defined in the result object 132 and the retrieved layout file.

Reference data 258 includes data that references third party resources (e.g., web servers and/or application servers). According to some implementations, at least a portion of the information used to render a displayed search result 132′ may be obtained from a third party resource. The reference data 258 may identify the third party resource from which the information may be obtained. In this way, application functions which depend on real-time data may be supported by the search engine 200. For example, an application may allow users to make reservations for restaurants. In this example, the reference data 258 may indicate an address of a server associated with the application where available reservation times may be obtained. In this way, the search engine 200 or the user device 300 can request and obtain the available reservation times at query-time or rendering-time, thereby insuring that the content that is presented in the displayed is valid and/or fresh data. The reference data 258 may include resource identifiers (e.g., web resource identifier) where the content may be obtained. In some implementations, the reference data 258 may additionally or alternatively define a location where a layout file may be obtained.

FIG. 2E illustrates a search module 212 according to some implementations of the present disclosure. The search module 212 can include a query analysis module 216, a set generation module 218, and a scoring module 220. The query analysis module 216 receives search queries 102 and outputs tokens based thereon. The set generation module 218 receives the tokens and identifies a consideration set of function records 240 (referred to as a “consideration set of records” or “consideration set”) based on the tokens. The consideration set of records may contain actual function records 240 or the function IDs 242 thereof. The scoring module 220 receives the consideration set of records and scores each function record 240 identified in the consideration set. The scoring module 220 can attribute the score of a function record 240 to its function ID 242. The scored function IDs 242 are output to the results processing module 214. The operation of the search module 212 is described in greater detail below.

The query analysis module 216 receives a search query 102, and in some implementations, context parameters (e.g., geolocation of a user device 300 or an operating system type of the user device 300). When the query analysis module 216 receives a search query 102, the query analysis module 216 analyzes the query terms of the search query 102 and/or the context parameters. For example, the query analysis module 216 may perform various analysis operations on the query terms of the received search query 102. Example analysis operations may include, but are not limited to, tokenization of the search query 102, filtering of the search query 102, stemming the query terms of the search query, synonymization of the search terms, and stop word removal. In some implementations, the query analysis module 216 outputs tokens representing the search query 102.

The set generation module 218 identifies a consideration set of records based on the tokens provided by the query analysis module 216. As used herein, the term consideration set of records can refer to a list of function IDs 242 or a collection of actual function records 240. In some examples, the set generation module 218 may identify the function records 240 based on matches between the tokens and terms contained in the function records 240. For example, the set generation module 218 may identify the function records 240 based on matches between tokens generated by the query analysis module 216 and terms included in the application state information 244 (which may also be tokenized). The set generation module 218 may further determine an initial score for each identified record (and not the result score of the record). In some implementations, the set generation module 218 may utilize the Apache Lucene libraries supported by the Apache Software Foundation to identify the consideration set and obtain the initial scores thereof.

The scoring module 220 scores the function records 240 indicated by the consideration set. The scores associated with the function records 240 may be referred to as “result scores.” The scoring module 220 may determine a result score for each of the function records 240 identified the consideration set. The result scores associated with a function record 240 may indicate the relative rank of relevance of the function record 240 with respect to the other function records 240. For example, a larger result score may indicate that a function record 240 is more relevant to the search query 102. The information conveyed by the search results 130 may depend on how the result scores are calculated by the scoring module 220. For example, the result scores may indicate the relevance of an application function or application state to the search query 102, the popularity of an application function or state, and/or other properties of the application function or state, depending on what attributes the scoring module 220 uses to score the function records 240.

The scoring module 220 may generate result scores for function records 240 in any suitable manner. In some implementations, the scoring module 220 generates a result score for a function record 240 based on one or more scoring features. The scoring features may be associated with the function record 240 and/or the search query 102. A function record scoring feature (hereinafter “record scoring feature”) may be based on any data associated with a function record 240. For example, record scoring features may be based on any data included in the application state information of the function record 240. Example record scoring features may be based on metrics associated with a person, place, or thing described in the function record 240. Example metrics may include the popularity of a place described in the function record and/or ratings (e.g., user ratings) of the place described in the function record 240. In one example, if the function record 240 describes a song, a metric may be based on the popularity of the song described in the function record 240 and/or ratings (e.g., user ratings) of the song described in the function record 240. The record scoring features may also be based on measurements associated with the function record 240, such as how often the function record 240 is retrieved during a search and how often access mechanisms of the function record 240 are selected by a user when appearing in the search results 130. Record scoring features may also be based on whether the function record 240 describes a default state or a deeper application state.

A query scoring feature may include any data associated with the search query 102. For example, query scoring features may include, but are not limited to, a number of words in the search query 102, the popularity of the search query 102 (e.g., how often the search query 102 is received by the search engine 200 or the total number of times the search query 102 has been received by the search engine 200), and the expected frequency of the words in the search query 102. A record-query scoring feature may include any data generated based on data associated with both the function record 240 and the search query 102 that resulted in identification of the function record 240 by the set generation module 218. For example, record-query scoring features may include, but are not limited to, parameters that indicate how well the terms of the search query 102 match the terms of the application state information of the identified function record 240 (e.g., the initial score assigned to the function record by the set generation module 218).

The scoring module 220 may generate a result score for a function record 240 based on at least one of the record scoring features, the query scoring features, and the record-query scoring features. The scoring module 220 may determine a result score based on one or more of the scoring features listed herein and/or additional scoring features not explicitly listed. In some examples, the scoring module 220 may include one or more machine learned models (e.g., a supervised learning model) configured to receive one or more scoring features. The one or more machine learned models may generate result scores based on at least one of the record scoring features, the query scoring features, and the record-query scoring features. For example, the scoring module 220 may pair the search query 102 with each function record 240 and calculate a vector of features for each (query, record) pair. The vector of features may include one or more record scoring features, one or more query scoring features, and one or more record-query scoring features. The scoring module 220 may then input the vector of features into a machine-learned regression model to calculate a result score for the function record 240. In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

The scoring module 220 associates each calculated result score with the function ID 242 of the record 240 to which the calculated score corresponds. The scoring module 220 can provide the scored function IDs 242 to the results processing module 214.

FIG. 2F illustrates an example data flow of the results processing module 214. The results processing module 214 receives scored function IDs 242 and generates result objects 132 based thereon. The results processing module 214 can determine which function IDs 242 on which to base result objects 132 according to the respective scores thereof. In some implementations, the results processing module 214 can rank the function IDs 242 based on their respective scores. The ranked list of function IDs 242 can define the order in which the displayed search results 132′ appear in the SERP. Additionally or alternatively, the results processing module 214 can discard any function IDs 242 whose result score does not exceed a threshold.

Furthermore, the results processing module 214 can determine the size and appearance of each displayed search result 132′ based on the respective scores. For instance, a displayed search result 132′ based on a function ID 242 that has a higher score can be sized bigger than an displayed search result 132′ that is based on a function ID 242 having a lower score. Additionally or alternatively, the results processing module 214 can determine whether the user device 300 is to initially display a displayed search result 132′ in a collapsed viewing mode or an expanded viewing mode. For instance, the results processing module 214 can instruct the user device 300 to display a displayed search result 132′ in an expanded viewing mode when the result score of the corresponding function ID exceeds a threshold or is in the highest nth percentile of result scores (e.g., in the top five percentile).

In operation, the results processing module 214 receives a scored function ID 242 and can generate a result object 132 based thereon. Assuming a function ID 242 has a requisite result score associated therewith (e.g., the result score of the function ID 242 is above a threshold or is in the nth percentile of function IDs 242), the results processing module 214 retrieves a result object record 250 from the data store 232 using the function ID 242. As was previously discussed, the result object records 250 store function IDs 242 of corresponding function records 240, according to some implementations. The retrieved result object record 250 includes at least a portion of the result object data used to generate a result object 132. The results processing module 214 generates a result object 132 based on the layout data 254 contained in the result object record 250. In some implementations, the retrieved result object record 250 includes a layout file (or a layout ID pointing to a layout file) and display data 252. The layout file may include a layout object that defines the structure and/or functions used to generate and manipulate a result object 132. In these implementations, the results processing module 214 can instantiate a result object 132 (or a portion thereof) based on the layout object. The results processing module 214 can populate fields defined in an instantiated result object 132 using the display data 252. For example, the results processing module 214 can assign values to various fields defined in the instantiated result object 132 using content defined in the display data 252 (e.g., application name, application state description, icons, etc.). Alternatively, the results processing module 214 may retrieve the function record 240 corresponding to the function ID 242 and populate the fields defined in the instantiated result object 132 using the application state information 244 defined in the function record 240. In some implementations, the results processing module 214 utilizes an output binding defined in the layout file to bind values in the display data 252 and/or the application state information 244 of the function record 240 to the instantiated result object 132.

The results processing module 214 inserts access mechanism data 256 in each instantiated result object 132. The user device 300 utilizes the access mechanism data 256 to access a state or function of an application indicated by the displayed search result 132′. In some implementations, the result object record 250 corresponding to a function ID 242 includes one or more access mechanisms (e.g., a web resource identifier, an application resource identifier, and/or a script) that can be used to access a state or function of an application. In these implementations, the result processing module 214 retrieves the access mechanisms from the result object record 250 and populates one or more fields of the instantiated result object 132 with the one or more access mechanisms. In some implementations, the results processing module 214 references a lookup table that associates function IDs with corresponding access mechanisms. In these implementations, the results processing module 214 identifies one or more access mechanisms from the lookup table based on their respective association with a function ID 242. The results processing module 214 populates one or more fields of the instantiated result object 132 with the identified access mechanisms. In some implementations, the access mechanism data 256 can define one or more specifications or templates for generating access mechanisms. In these implementations, the results processing module 214 includes one or more of the specifications or templates defined in a record 250 in the result object 132, such that the user device 300 can generate an access mechanism to access a state or function of an application based on the specification or template and the input entered into a displayed search result 132′ by a user.

In some scenarios, the layout data 254 defines multiple layouts corresponding to different viewing modes (e.g., expanded or collapsed). In some implementations, the results processing module 214 determines whether the user device 300 is to initially display a displayed search result 132′ in a collapsed viewing mode or an expanded viewing mode based on the result score of a function ID 242 and/or the relative ranking of a function ID 242 to other function IDs. If a function ID 242 has a requisite result score, the results processing module 214 can set a flag in the corresponding result object 132 that instructs the user device 300 to initially display the displayed search result 132′ in an expanded viewing mode. In some implementations, the default viewing mode is the collapsed viewing mode, whereby all collapsible displayed search results 132′ are initially displayed in a collapsed viewing mode.

The results processing module 214 can transmit the generated result objects 132 to the user device 300 which transmitted the search query 102. The user device 300 receives and renders the search results 130 into displayed search results 132′.

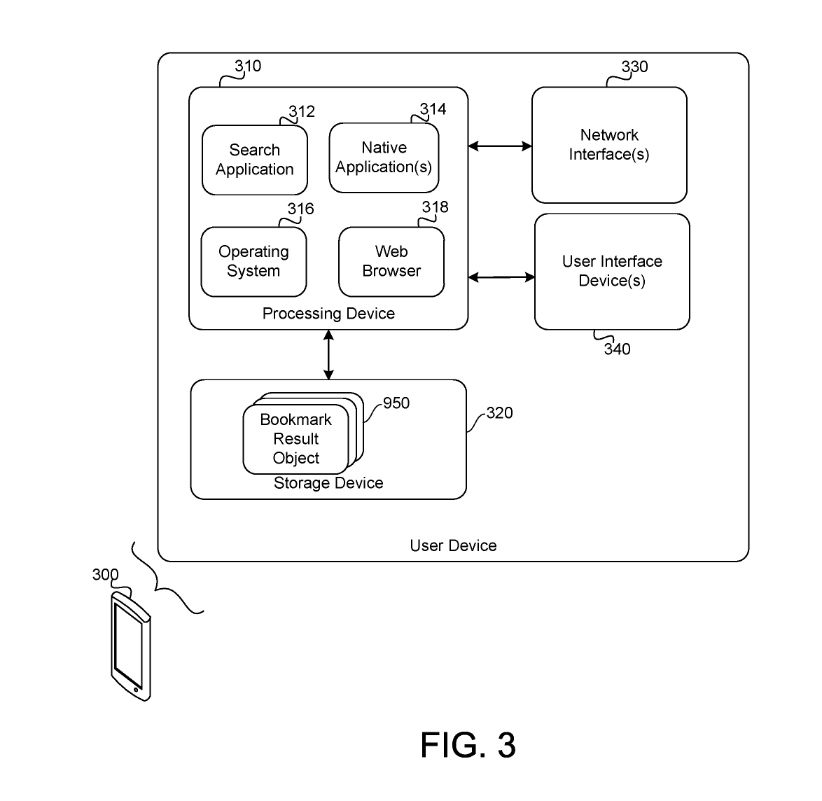

FIG. 3 illustrates a user device 300 configured to facilitate searches. In particular, the user device 300 is configured to provide search queries 102 to the search engine 200 and to render search results 130 received from the search engine 200. In the illustrated example, the user device 300 includes a processing device 310, a storage device 320, a network interface 330, and a user interface 340.

The processing device 310 includes memory (e.g., RAM and/or ROM) that stores computer readable instructions and one or more processors that execute the computer readable instructions. In implementations where the processing device 310 includes two or more processors, the processors can execute in a distributed or individual manner. The processing device 310 may execute a search application 312, an operating system 316, a web browser 318, and one or more native applications 314, all of which may be embodied as computer readable instructions. The storage device 320 includes one or more computer readable mediums (e.g., hard disk drive and/or flash memory). The storage device 320 can store the computer readable instructions that make up the search application 312, the web browser 318, the operating system 316, and the one or more native applications 314. In some implementations, the storage device may store a plurality of bookmark result objects (discussed with respect to FIGS. 9A-11).

The network interface 330 includes one or more devices that are configured to communicate with the network. The network interface 330 can include one or more transceivers for performing wired or wireless communication. Examples of the network interface 330 can include, but are not limited to, a transceiver configured to perform communications using the IEEE 802.11 wireless standard, an Ethernet port, a wireless transmitter, and a universal serial bus (USB) port. The user interface 340 includes one or more devices that receive input from and/or provide output to a user. The user interface 340 can include, but is not limited to, a touchscreen, a display, a QWERTY keyboard, a numeric keypad, a touchpad, a microphone, and/or speakers

The search application 312 displays a search bar and receives search queries 102 via the search bar. In particular, a user can enter one or more query terms into the search bar. In some implementations, the search application 312 waits until the user executes the search (e.g., presses upon a “search” button displayed in relation to the search bar) to transmit a search query 102 to the search engine 200. In response to the search query 102, the search engine 200 responds with search results 130. The search application renders and displays the search results 130 in the SERP.

In other implementations, the search application 312 transmits the contents of the search query 102 as the user enters the query terms. In these implementations, the search application 312 can transit a new search query 102 each time the user enters a character into the search bar and the search engine 200 can update the search results 130 as the user continues to enter the search query 102. In response to the updated search results 130, the search application 312 renders and displays the search results 130 in the SERP.

The search application 312 can receive a user selection of a displayed search result 132′. In response to the selection of a displayed search result 132′, the search application 312 can access a state or function of the application indicated by the displayed search result 132′. In some scenarios, a displayed search result 132′ includes one or more input elements 134. In the instance that a user respectively enters one or more values into the one or more input elements 134, the search application 312 obtains an access mechanism for accessing the application and accesses the application indicated by the displayed search result 132′ using the access mechanism. In some implementations, the result object 132 from which the displayed search result 132′ was rendered includes one or more specifications or templates for generating an access mechanism given a set of parameter types. For example, if a displayed search result 132′ allows a user to enter values for making hotel reservations (e.g., FIG. 1C), the user may enter a location (e.g., a city name), a check-in date, a checkout date, a number of rooms, and a number of guests. The search application utilizes the inputted values to obtain an access mechanism. In some implementations, the search application 312 obtains one or more access mechanisms that are based on the inputted values using access mechanism data 256 transmitted in the result object 132 on which the selected displayed search result 132′ was based. For example, the search application 312 may utilize a template to generate an application resource identifier given a set of parameters (e.g., a location, a check-in date, a checkout date, a number of guests, and a number of rooms). The search application 312 can utilize an input binding or similar mechanism to identify the parameter type of each value. For each identified parameter type, the search application 312 can populate a corresponding field in the template with the inputted value that was mapped to the parameter type. In this way, the search application 312 generates an application access mechanism that accesses a state or function of the native application edition of the application using the inputted parameters. The access mechanism data can include templates or specifications for generating scripts and/or resource identifiers. The search application 312 can generate scripts and/or resource identifiers in the manner described above. In other implementations, the search application 312 provides a request to the search engine 200 to generate one or more access mechanisms given the inputted values. The requests can include fields defining different parameter types, and each fields may have an inputted value assigned thereto. In response to the request, the search engine 200 generates one or more access mechanisms based on the inputted values and transmits the one or more access mechanisms to the user device 300. In some implementations, the search engine 200 generates the one or more access mechanisms in the manner described above.

When a user selects a displayed search result 132′, the search application 312 accesses a state or function of an application using an access mechanism. Accessing an application can include determining whether a native application edition of the application referenced by the access mechanism is installed on the user device 300. If so, the search application 312 instructs the operating system of the user device 300 to launch the native application and to set the state of the native application in accordance with the access mechanism. In some implementations, if a native application edition of the application is not installed, the search application can instruct the operating system to launch the web browser application and access the state of the web application edition of the application using a web resource identifier. Additionally or alternatively, the search application 312 can prompt a user to download the application. In this scenario, the search application 312 can instruct the operating system to launch a digital distribution application, whereby the user can elect to download the native application edition. In such implementations, the search application 312 can access the state of the application once the native application edition is downloaded.

If a displayed search result 132′ includes a resize element 139 and the user selects the resize element 139, the search application 312 adjusts the viewing mode of the displayed search result 132′. In some implementations, the result objects 132′ from which displayed search results 132′ are generated can define multiple layouts of the displayed search result 132′, such that the result objects 132′ support multiple viewing modes (e.g., collapsed and expanded). In these implementations, the search application 312 can initially display the search result 132′ in a default viewing mode (e.g., in a collapsed viewing mode). Additionally or alternatively, the search application 312 can initially display the search result 132′ in accordance with an instruction in the result object 132. For example, if the result object 132 has a flag set that indicates that the search result 132′ is to be initially displayed in an expanded viewing mode, the search application 312 displays the search result in the expanded viewing mode, as defined in the layout data contained in the result object 132.

When the user selects (e.g., presses on) the resize element 139 of a displayed search result 132′, the search application 312 adjusts the viewing mode of the displayed search result 132′. For instance, if the displayed search result 132′ is in a collapsed viewing mode, and the user selects the resize element 139, the search application 312 can render and display the displayed search result 132′ in an expanded viewing mode. Similarly, if the displayed search result 132′ is in an expanded viewing mode, and the user selects the resize element 139, the search application 312 can render and display the displayed search result 132′ in a collapsed viewing mode. In some implementations, the search application 312 parses the result object 132 and identifies the layout data corresponding to the selected viewing mode, and renders the displayed search result 132′ based on the identified layout data.

In some implementations, the search application 312 receives result objects 132 that include reference data that identifies a resource from which the search application 312 can obtain real-time data of an application. For example, a restaurant review application requires real-time data that indicates what reservation times are available. Similarly, a sports news application requires real-time data that indicates scores of on-going matches or games. In some of these implementations, the search application 312 initially renders and displays the displayed search result 132′ in a collapsed viewing mode. When a user selects the resize element 139 of the displayed search result 132′, the search application 312 generates a request to the application resource (e.g., a web server or application server) and transmits the request thereto. The application resource returns the requested data to the search application 312. The search application 312 may then render the displayed search result 132′ in the expanded viewing mode using the real-time data received from the application resource. In some implementations, the search application 312 utilizes an output binding to bind the received data to an instantiated layout object, as was described above. In this way, the search application 312 can include real-time data in a displayed search result 132′ and at the same time conserve bandwidth consumption, as requests to an application resources are only transmitted to the application resource when the user is interested in the real-time data.1

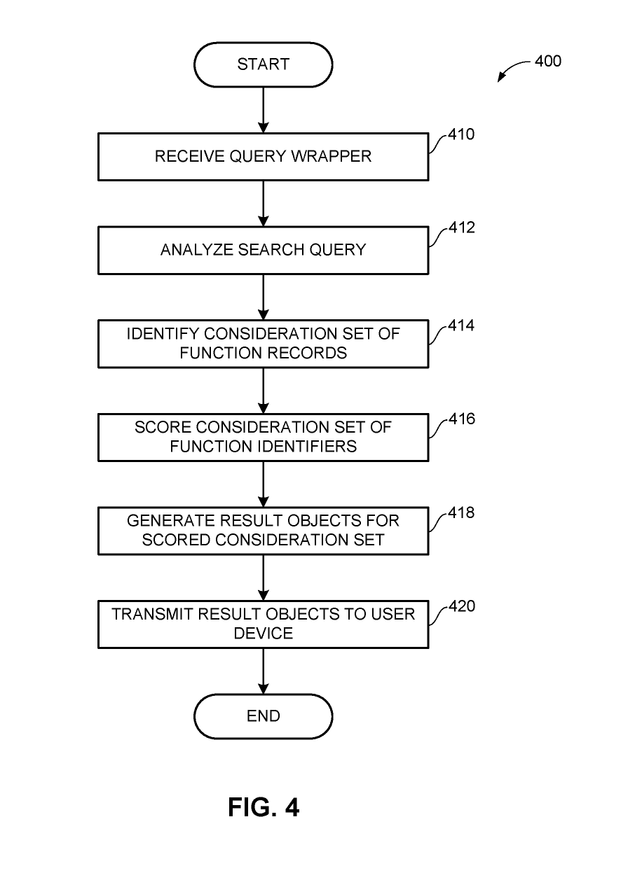

FIG. 4 illustrates an example set of operations of a method 400 for processing a search query 102. For purposes of explanation, the method 400 is explained with respect to the search engine 200 of FIGS. 2A-2F and is executed by the processing device 210 thereof. The method 400 may, however, be executed on any suitable computing device.

At operation 410, the query analysis module 216 receives a query wrapper 100 from a user device 300. The query wrapper 100 contains a search query 102 and may contain additional context parameters 104. At operation 412, the query analysis module 216 analyzes the search query 102, and in some implementations, the additional context parameters 104. The query analysis module 216 parses and analyzes the search query 102 and outputs one or more tokens. As previously discussed, the search query 102 contains one or more query terms. The query analysis module 216 can stem the search query 102, synonymize the search query 102, remove stop words from the search query 102, and/or tokenize the search query 102. The query analysis module 216 outputs one or more tokens representing the search query 102 (and potentially the context parameters) to the set generation module 218.

At operation 414, the set generation module 218 identifies a consideration set of function records based on the one or more tokens. The set generation module 218 can search the data store 232 using the tokens. As previously discussed, in some implementations the set generation module 218 utilizes the Lucene Library to search and identify a consideration set of function records 240. The consideration set of function records 240 includes function IDs 242 of function records 240 (or the function records 240 themselves) that at least matched a minimum number of tokens to the search query 102. In some implementations, each function record 240 identified in the consideration set is also provided an initial score based on the degree to which the function record 240 matched to the tokens of the search query 102. The set generation module 218 outputs the consideration set to the scoring module 220.

At operation 416, the scoring module 220 scores each record in the consideration set and outputs the scored consideration set to the results processing module 214. The scoring module 220 receives the consideration set from the set generation module 218. For each function ID 242, the scoring module 220 can retrieve the corresponding function record 240 and calculate a score based on the contents of the record 240. In some implementations, the scoring module 220 includes a machine-learned scoring model that scores a function record 240 based on a number of scoring features, including features of the function record 240, features of the search query 102, and/or features of the function record 240 as it relates to the search query 102. The scoring module 220 outputs the scored consideration set of records to the results processing module 214.

At operation 418, the results processing module 214 generates result objects 132 based on the scored consideration set. In some implementations, the results processing module 214 ranks the function IDs 242 included in the consideration set based on the respective results scores of the function IDs 242. Additionally or alternatively, the results processing module 214 determines the function IDs 242 on which to base the search results 130 based on the results scores. For instance, the results processing module 214 can keep function IDs 242 having results scores that exceed a minimum threshold or the function IDs 242 having results scores in the nth highest percentile.

The results processing module 214 generates result objects 132 based on the function IDs 242 that are kept. In some implementations, the results processing module 214 retrieves result object records 250 from the data store 232 using the function IDs 242. For each retrieved result object record 250, the results processing module 214 generates a result object 132 using the layout data 254 and the access mechanism data 256. Furthermore, the results processing module 214 can include display data 252 in the result object 132 and/or reference data 258 (which identifies resources where additional data can be requested). In some implementations, the results processing module 214 instantiates a layout object from a layout file and binds content to the layout object using an output binding. The content may be defined in the display data 252 and/or the application state information 244 defined in the function record 240 corresponding to the function ID 242 on which the result object 132 is based. In some implementations, the results processing module 214 determines whether the displayed search result 132′ is to be displayed in a collapsed or expanded viewing mode based on the result score of the function ID 242. In these implementations, the results processing module 214 can set a flag based on the determination. At operation 420, the results processing module 214 transmits the generated result objects 132 to the user device 300 that transmitted the request.

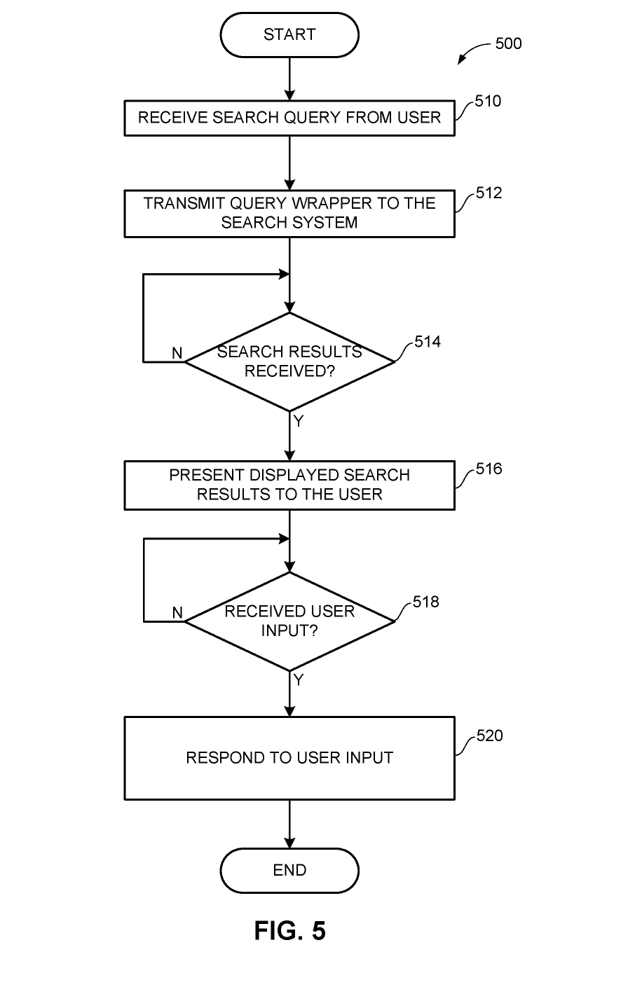

FIG. 5 illustrates an example set of operations of a method 500 for performing a search on a user device 300. The method 500 is explained with reference to the search application 312 being executed by the processing device 310 of the user device 300. The method 500, however, may be performed by any suitable application executing on the user device 300.

At operation 510, the search application 312 receives a search query 102 from a user. A user can enter the search query 102 into a search bar displayed in a GUI by the search application 312. The search application 312 can determine any additional context parameters to include in the search query 102 (e.g., geolocation, operating system type, username, etc.).

At operation 512, the search application 312 transmits a search query 102 to the search engine 200. The search application 312 can generate a query wrapper 100 that contains the search query 102 and, in some implementations, any context parameters determined by the search application 312. The search application 312 can transmit the search query 102 when the user instructs the search application 312 to transmit the search query 102 (e.g., by pressing a “search” button) or each time the user enters a new character in the search bar.

At operation 514, the search application 312 waits to receive search results 130 from the search engine 200. When the search application 312 receives the search results 130, the search application 312 renders the result objects 132 contained in the search results 130 into respective displayed search results 132′ and presents the displayed search results 132′ in the SERP, as shown at operation 516. In some scenarios, a displayed search result 132′ can be presented in a collapsed viewing mode or a displayed viewing mode. One or more of the displayed search results 132′ may include input elements 134.

At operation 518, the search application 312 waits for user input, and when user input is received, the search application 312 responds to the user input. In some scenarios, a user provides user input in relation to a displayed search result 132′ that includes input elements 134. In these scenarios, user input can include entering values into one or more input elements 134, selection of a tab 138, selection of a resize element 139, selection of a header 137, and/or selection of a selection element 136.

In the case a user selects a tab 138, the search application 312 alters the information displayed in the displayed search result 132′. For example, a displayed search result 132′ may display a first set of input elements 134 to access a first function of an application, while a tab 138 may indicate a second set of input elements 134 to access a second function of an application, whereby the second set of input elements 134 are not shown in the displayed search result 132′. In response to selection of the tab 138 (e.g., pressing on the tab 138), the search application 312 alters the appearance of the displayed search result 132′ thereby displaying a portion of the displayed search result 132′ corresponding to the hidden elements (e.g., the second set of input elements 134).

In the case a user enters values into one or more input elements 134, the search application 312 can display the inputted values in the input elements 134. The user can then select a selection element 136 to execute the displayed search result 132′. In response to selection of the selection element 136, the search application 312 obtains one or more access mechanism(s) corresponding to the inputted values. In some implementations, the search application 312 requests the access mechanism(s) from the search engine 200, whereby the request includes the inputted values. In other implementations, the search application 312 generates the access mechanisms(s) using a specification or template defined in the result object 132 and the inputted values. The search application 312 can then access the state or function of the application using one of the one or more access mechanisms. For instance, the search application 312 can determine whether a native application edition of the application is installed on the user device 300, and if so, instruct the operating system to launch the native application edition using the access mechanism. The operating system launches the native application edition and sets the state of the application in accordance with the access mechanism (in this case an application access mechanism). If the native application edition is not installed, the search application 312 can instruct the operating system to launch the web browser application and to access the state or function of the application using a web resource identifier.

In some implementations, the selection of a header element 137 causes the search application 312 to access a default state of an application. For instance, the search application 312 can determine whether a native application edition of the application is installed on the user device 300, and if so, the search application 312 instructs the operating system to launch the native application edition to a default state using a default application access mechanism. The operating system launches the native application edition and sets the state of the application to the default state.

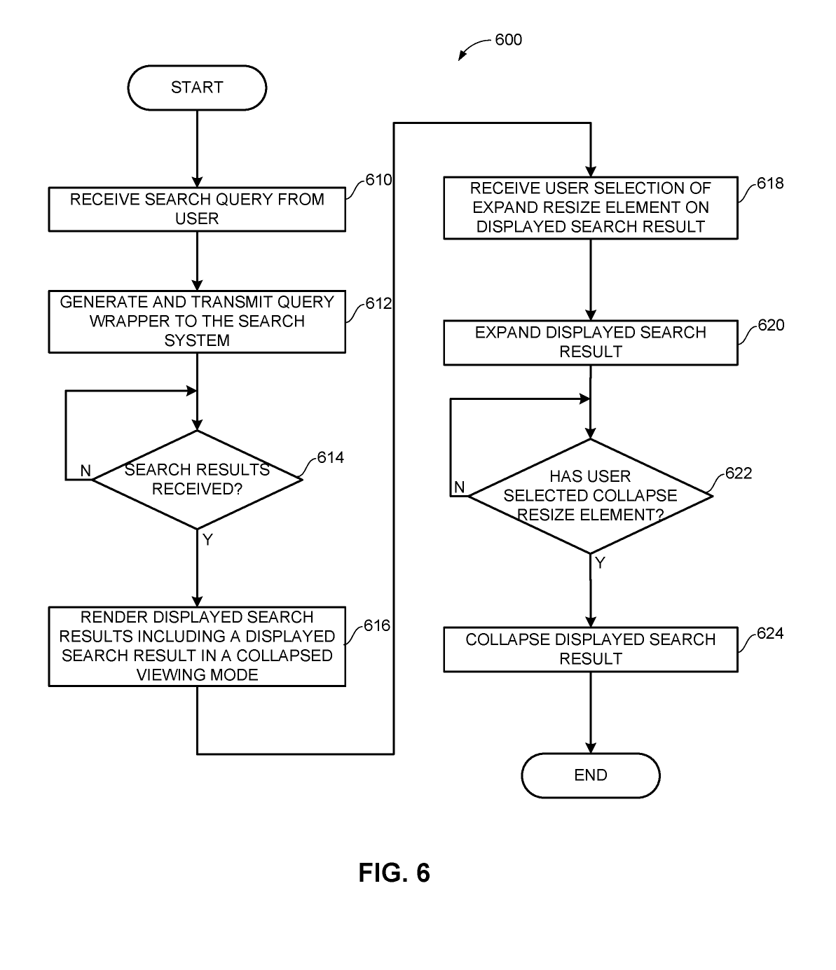

FIG. 6 illustrates an example set of operations for a method 600 for responding to a user selection of a resize element 139. The method 600 is explained with respect to the search application 312. The method 600, however, may be executed by any suitable application.

At operation 610, the search application receives a search query 102 from a user, as described above. At operation 612, the search application 312 transmits the search query 102 to the search engine 200. As was described above, in some implementations the search application 312 generates a query wrapper 100 containing the search query 102 and zero or more context parameters. The search application 312 transmits the query wrapper 100 to the search engine 200. At operation 614, the search application 312 waits for search results 130.

At operation 616, the search application 312 renders and presents displayed search results 132′ based on the received search results 130. The displayed search results 132′ include a modifiable displayed search result 132′. In this example, the search application 312 renders and presents the modifiable displayed search result 132′ in a collapsed viewing mode. In some implementations, the search application 312 utilizes a portion of a result object 132 defining the collapsed viewing mode to render the displayed search result 132′. The displayed search result 132′ includes a resize element 139.

At operation 618, the search application 312 receives a user selection of a resize element 139. For example, the user may press or click on the resize element 139. At operation 620, the search application 312 expands the displayed search result 132′. For example, the search application 312 can render a portion of the result object 132 corresponding to the expanded viewing mode, and can replace the collapsed viewing mode representation of the displayed search result 132′ with the expanded viewing mode representation thereof. The collapsed viewing mode representation of the displayed search result 132′ also includes a resize element 139. At operation 622, the search application 312 waits for a user selection of the resize element 139. In response to the user selection of the resize element 139, the search application 312 collapses the displayed search result 132′. For example, the search application 312 can render a portion of the result object 132′ corresponding to the collapsed viewing mode, and can replace the expanded viewing mode representation of the displayed search result with the collapsed viewing mode representation. In accordance with the method described above, the search application can toggle between the expanded viewing mode representation and the collapsed viewing mode representation.

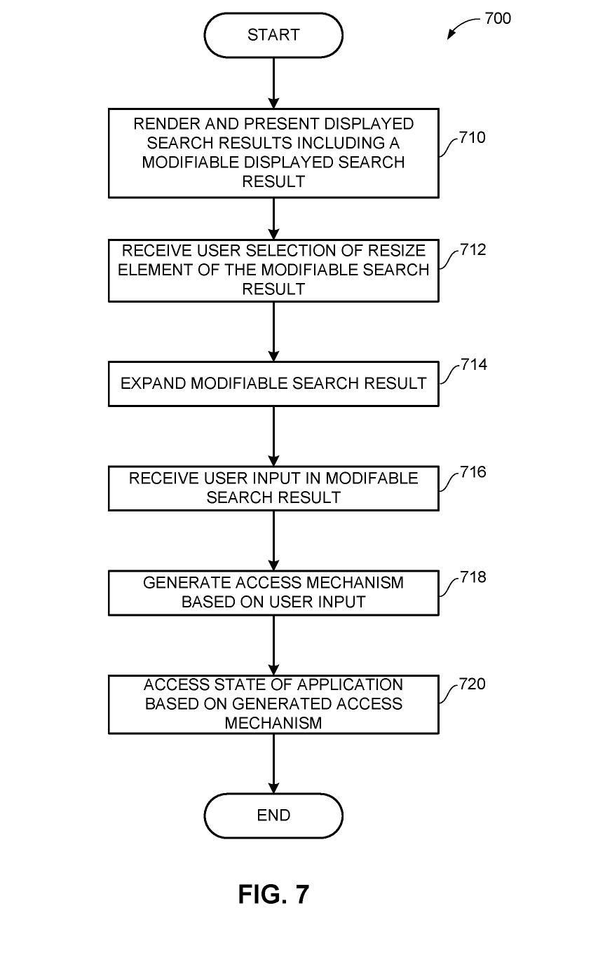

FIG. 7 illustrates an example set of operations of a method 700 for accessing a state of an application. The method 700 is explained with respect to the search application 312. The method 700, however, may be executed by any suitable application.

At operation 710, search application 312 renders and presents displayed search results 132′ in the SERP, including a modifiable search result 132′. The search application 312 receives the search results 130 in response to a search query 102, as was described above. In some implementations, the result object 132 from which a modifiable search result 132′ is generated includes a flag indicating whether the modifiable search result 132′ is to be rendered in a collapsed or expanded viewing mode. Additionally or alternatively, the modifiable search result 132′ is rendered and presented in a default viewing mode (e.g., a collapsed viewing mode). In this example, the modifiable search result 132′ is initially presented in a collapsed viewing mode.

At operation 712, the search application 312 receives a user selection of a resize element 139 displayed in relation to the modifiable search result 132′. For instance, the user may press on the resize element 139. At operation 714, the search application 312 expands the modifiable search result 132′. The search application 312 can render and present the modifiable search result 132′ in an expanded viewing mode, as was described above. At operation 716, search application 312 receives user input in one or more input elements of the modifiable search result 132′. The user may enter values into the input elements 134 via the user interface 340 of the user device 300. The user can then execute the modifiable search result 132′ by, for example, selecting a selection element 136 displayed in relation to the modifiable search result 132′.

At operation 718, the search application 312 generates one or more access mechanisms based on the values entered into the input elements 134. In some implementations, the search application 312 associates the values inputted by the user with parameter types accepted by the application indicated by the modifiable search result 132′ using an input binding. As previously discussed, an input binding may be communicated in the result object 132 from which the modifiable search result 132′ is rendered. The input binding associates the input elements 134 to respective parameter types accepted by the application indicated by the search result 132′. In this way, the search application 312 can associate the inputted values to the parameter types accepted by the application. The search application 312 then generates one or more access mechanisms based on access mechanism data 256 contained in the result object 132 from which the modifiable search result 132′ was generated. For example, the access mechanism data 256 may contain a first template for generating an application resource identifier and a second template for generating a web resource identifier. In some examples, the templates include a first portion that indicates the web or native application edition of the application and a second portion that defines a scheme for accessing a state or function of the application. The scheme may include fields that respectively define parameter types and receive values. The search application 312 can substitute the values inputted into the modifiable search results into the fields of the templates. In some implementation, the search application 312 utilizes the associations between the inputted values and the known parameter types to populate the fields of the templates, thereby generating the access mechanisms. The search application 312 may generate the access mechanisms in any other suitable manner. For instance, the search application 312 may utilize a specification that defines instructions for generating access mechanisms for a particular application given a set of inputted values with known parameter types.

At operation 720, the search application 312 accesses the application using the generated access mechanism(s). As was previously discussed, the search application 312 may determine whether a native application edition of the application is installed on the user device 300, and if so, the search application 312 the native application edition using an application resource identifier. Otherwise, the search application 312 may access a web application edition of the application using a web resource identifier. Additionally or alternatively, the search application 312 may prompt the user to download a native application edition of the application if it is not already installed on the device 300. In such a scenario, the search application 312 may access the downloaded native application edition using the application resource identifier upon receiving confirmation that the native application edition has been downloaded to and installed on the user device 300.

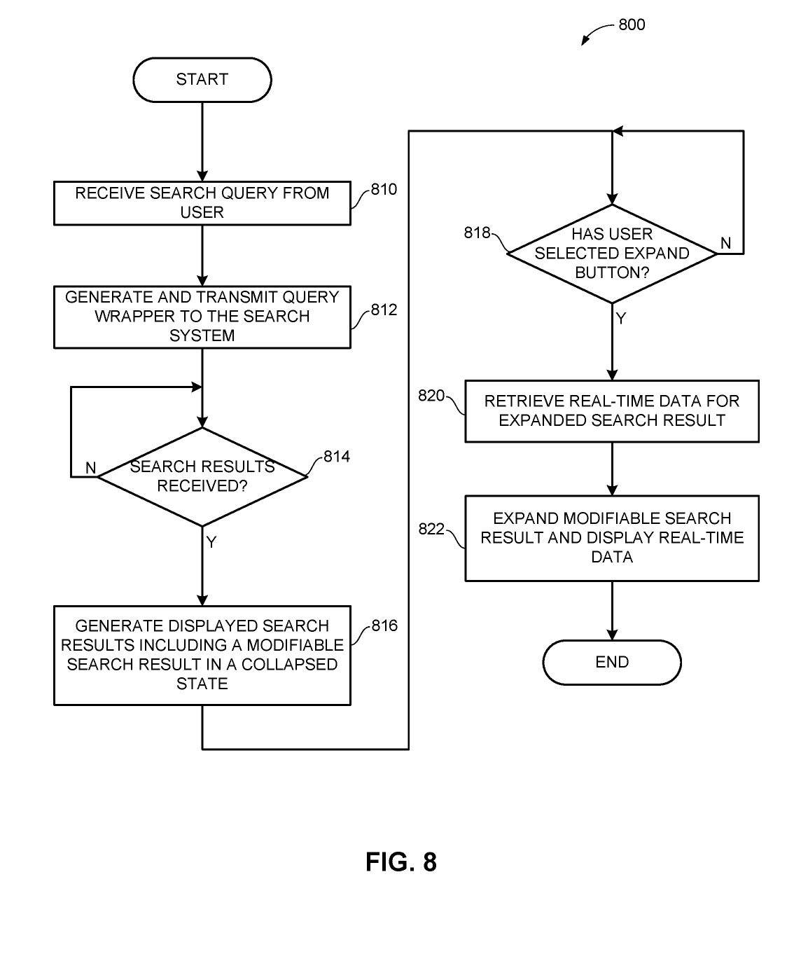

FIG. 8 illustrates an example set of operations for a method 800 for presenting real-time data in a modifiable search result 132′. The method 800 is explained with respect to the search application 312. The method 800, however, may be executed by any suitable application.

At operation 810, the search application receives a search query 102 from a user, as described above. At operation 812, the search application 312 transmits the search query 102 to the search engine 200. As was described above, in some implementations the search application 312 generates a query wrapper 100 containing the search query 102 and zero or more context parameters. The search application 312 transmits the query wrapper 100 to the search engine 200. At operation 814, the search application 312 waits for search results 130.

At operation 816, the search application 312 renders and presents displayed search results 132′ based on the received search results 130. The displayed search results 132′ include a modifiable displayed search result 132′. In this example, the search application 312 renders and presents the modifiable displayed search result 132′ in a collapsed viewing mode based on the contents of a corresponding result object 132. In some implementations, the search application 312 utilizes a portion of a result object 132 defining the collapsed viewing mode to render the displayed search result 132′. The displayed search result 132′ includes a resize element 139. In this example, the result object 132 includes reference data 258 that indicates a resource (e.g., an application server or web server related to the application) that provides real-time data.

At operation 818, the search application 312 waits for a user selection of a resize element 139. For example, the search application 312 may wait for a user to press or click on the resize element 139. Upon receiving the user selection of the resize element 139, the search application 312 obtains real-time data from the resource indicated in the result object 132 from which the modifiable search result 132′ was rendered, as shown at operation 820. In some implementations, the search application 312 transmits a request to the resource using the reference data 258 defined in the result object 132. The resource responds with the real-time data. At operation 822, the search application 312 renders and presents the modifiable search result 132′ in the expanded viewing mode. In some implementations, the search application 312 can render the expanded viewing mode representation of the modifiable search result 132 and can bind the real-time data to the modifiable search result 132 in accordance with an output binding. The search application 312 presents the modifiable search result 132 in the SERP in the expanded viewing mode. In this way, the search results 130 can present real-time data in the search results 130, while reducing bandwidth consumption as well as conserving real estate in the SERP until it is needed.

The methods 400, 500, 600, 700, 800 described above are provided for example only and not intended to limit the scope of the disclosure. The ordering of the operations is not mandatory and some operations may be performed in parallel. Further alternate or additional operations not explicitly described may be performed as well.

Referring back to FIG. 3, the search application 312 can be configured to bookmark search results 130, according to some implementations of the present disclosure. Typically, users of mobile user devices open a native application to discover relevant content based on their current context (e.g., location, preferences, parameters). For example, if a user wants to locate nearby restaurants, the user can launch a native application edition of a restaurant-related software application and enter a location and/or a cuisine type to find nearby restaurants. Similarly, if a user wants to find a taxi, the user can launch a native application edition of a ride-sharing application to locate a nearby taxi and may further have to enter one or more input values into the user interface of the native application (e.g., a type of car, a drop-off location, etc.). In yet another example, a user may wish to make a flight reservation. To access such functionality, the user may have to launch a flight-reservation native application and to enter many values into the GUI of the native application. For example, the user may have to enter a departure date, a return date, a departure airport, an arrival airport, and a number of passengers. Furthermore, some of these types of actions are done regularly by users. In the case of the flight-reservation application, the user may wish to search for flights over the course of a week to ensure that a reasonable flight price is found or to compare flight prices between two or more different destinations.

In some implementations of the present disclosure, the search application 312 is configured to bookmark individual search results 132′. Bookmarking a search result 130 can refer to saving at least some information regarding the search result 130, whereby the user can retrieve the search result 130 at a later time. As previously discussed, the search application 312 may display one or more displayed search results 132′ that include one or more input elements 134. These input elements 134 allow a user to enter values that can be used to access a “deeper” state of the software application. When a user bookmarks a search result 132′, the search application 312 can store the values that the user input into the input elements 134, whereby when the user opts to view a bookmarked search result, the search application 312 can retrieve content from the software application corresponding to the bookmarked search result using the stored values and may display retrieved content in the bookmarked search result. In this way, the user does not need to reenter search queries 102 and/or reenter input values into the GUI to rerun a search.

FIGS. 9A and 9B illustrate examples of a user device 300 displaying search results 132′ that the user can bookmark. In FIG. 9A, the user has entered the query term “burritos” as the search query 102. In response to the search query 102, the search application 312 determines the context parameters 104 (e.g., geolocation of the user device 300) and transmits the search query 102 and context parameters 104 to the search engine 200. In this example, the search engine 200 returns search results 130 corresponding to the search query “burritos” and a geolocation in Mountain View, Calif. The search application 312 renders the search results 130 and displays displayed search results 132′ that include a displayed search result 132′ linking to a software application named “Trip Mate.” The user can select one or more links in the displayed search result 132′ to access a state of the Trip Mate application (e.g., access a state relating to “Taqueria Los Charros” or another state relating to “La Costena”). In some implementations, the result object 132 corresponding to the Trip Mate application may include information that the search application 312 uses to request content from the Trip Mate software application. For example, the information may include an instruction for issuing an API call to the Trip Mate software application. The API call can indicate the term “burritos” and may further include the geolocation of the user device 300. The software application may issue an API call to the Trip Mate software application to identify the deeper states of the Trip Mate software application (e.g., a first state relating to “Taqueria Los Charros,” a second state relating to “La Costena,” and a third state relating to “Los Altos Taqueria”).

The Trip Mate displayed search result 132′ includes a header 137. The header 137 includes a bookmarking input element 902. In this example, the user has selected the bookmarking input element 902. In response to the user selection, the search application 312 can store bookmarking information relating the displayed search result 132′. For instance, the search application 312 can store the layout file used to render the displayed search result, as well as the information used to request content from the Trip Mate software application (e.g., the API call). As will be discussed, when the user accesses the bookmarked search results, the search application 312 can request content from the software application, such that the content used to render a bookmarked search result is up-to-date content.

In FIG. 9B, the user has entered the query term “taxi” as the search query 102. In response to the search query 102, the search application 312 determines the context parameters 104 (e.g., geolocation of the user device 300) and transmits the search query 102 and context parameters 104 to the search engine 200. In this example, the search engine 200 returns search results 130 corresponding to the search query “taxi” and a geolocation in Mountain View, Calif. The search application 312 renders the search results 130 and displays displayed search results 132′ that include a displayed search result 132′ linking to a software application named “Super Car.” The Super Car application allows a user to order a taxi to their current location. Furthermore, the user can select one or more types of cars (e.g., a taxi or a black car). In response to selecting the search query 102, the search application 312 can instruct the user device 300 to launch a native application edition of the Super Car and can indicate that the user has requested a black car. Additionally, the search application 312 may receive information in the result object 132 corresponding to the Super Car application that the search application 312 uses to request information from the Super Car application (e.g., an instruction to issue an API call using the geolocation of the user device). The search application 312 can request availability information from the Super Car application using, for example, an API call that indicates the geolocation of the user device 300. The Super Car application returns availability information corresponding to the geolocation provided in the API call. The availability information may be displayed in the search result 132′ of the Super Car application, as shown in FIG. 9B.

In FIG. 9B, the user can bookmark the search result 132′ corresponding to the Super Car application. For example, the user can select the bookmarking input element 902. In response to the user selection of the bookmarking input element 902, the search application 312 can store bookmarking information relating the Super Car search result 132′. For example, the search application 312 can store a layout file corresponding to the Super Car search result 132′ and the request information used to request information from the Super Car application.

The examples of FIGS. 9A and 9B are provided for example only and not intended to limit the types of search results that can be bookmarked. An individual displayed search result 132′ can include any suitable input elements. When the user parameterizes a displayed search result 132′ with one or more values (e.g., by entering values in one or more input elements 134) and bookmarks the search result 132′, the search application 312 can store the values in the bookmarking information. When the user elects to view his or her bookmarked search results the values can be used to request information from the software application corresponding to the bookmarked search result.

FIG. 9C illustrates an example of the user device 300 displaying a bookmark SERP 910 that displays bookmarked search results 932. In some implementations, the search application 312 displays the bookmark SERP 910. A user can access the bookmark SERP 910 for example, by swiping to the left or right from the main SERP (e.g., FIG. 9A or 9B). Additionally or alternatively, the user may select a bookmark tab or menu option to access the bookmark SERP 910. In some implementations, accessing the bookmark SERP 910 can activate the bookmarked search results 932. Alternatively, a user may select one or more of the bookmarked search results 932 to activate the bookmarked search results. Activating a bookmarked search result 932 can refer to instructing the search application 312 (or any other suitable application that bookmarks search results) to render the bookmarked search results with updated content.

In the example of FIG. 9C, the bookmark SERP 910 is displaying a first bookmarked search result 932-1 and a second bookmarked search result 932-2. The first bookmarked search result 932-1 corresponds to the Super Car application and the second bookmarked search result 932-2 corresponds to the Trip Mate application. In the example of FIGS. 9A and 9B, the user was in Mountain View, Calif. when the search queries 102 (e.g., “burritos” and “taxi”) were transmitted to the search engine 200. As was described with respect to FIGS. 9A and 9B, the user bookmarked the Super Car application search result 132′ (FIG. 9B) and the Trip Mate application search result 132′ (FIG. 9A). When the user accesses the bookmark SERP 910, the search application 312 can activate the first and second bookmarked search results 932-1, 932-2.

In activating the first bookmarked search result 932-1, the search application 312 transmits a request to the Super Car software application. In some implementations, the search application 312 issues an API call to the Super Car software application (e.g., transmits an HTTP request to a server of the Super Car software application). The API call can include a current geolocation of the user device 300 and can indicate that the user is requesting the availability of black cars only. A server of the Super Car software application can respond to the API call with availability of black cars in the vicinity of the current location of the user device 300. The search application 312 receives the availability information and renders the bookmarked search result 932-1 using the received availability information. In the illustrated example, the user device 300 is in San Francisco, Calif. when the bookmarked search result 132-1 is accessed. Thus, the bookmarked search result 132-1 displays availability of black cars in the vicinity of the user device in San Francisco, Calif.

In activating the second bookmarked search result 132-2, the search application 312 transmits a request to the Trip Mate software application. In some implementations, the search application 312 issues an API call to the Trip Mate software application. The API call can include the current geolocation of the user device 300 as well as the search query 102 originally entered by the user (e.g., “burritos”). As previously mentioned, at the time of activation the user device 300 is in San Francisco instead of Mountain View. Thus, the API call can provide a geolocation in San Francisco along with the query term “burritos” to a server of the Trip Mate software application. The Trip Mate server returns content that indicates states of software applications that are relevant to the location and the query term “burritos.” The search application 312 can bind the content to a layout file corresponding to the Trip Mate software application. The search application 312 can then render a bookmark search result 932 based on the layout file and the content. In this example, a user can select a first link 904-1 to a first state of the Trip Mate application relating to “The Little Chihuahua,” a second link 904-2 to a second state of Trip Mate application relating to “Taqueria Cancun,” a third link 904-3 to a third state of the Trip Mate application relating to “La Tortilla.” In this way, as the user moves to different locations, the content provided by the Trip Mate software application may change. Further, because the query terms provided to the Trip Mate software application remain the same (e.g., “burritos”), the content provided by the Trip Mate software application should remain relevant to the query terms.

As shown in FIG. 9C, the bookmarked search results 932 may be displayed as a list, e.g., in a vertical orientation. The bookmarked search results 932 may be displayed in any other suitable orientation (e.g., horizontal orientation). In some scenarios, a bookmarked search results 932-1 may have the same layout as the corresponding displayed search result 132′. In other scenarios, the bookmarked search results 932 may a different appearance from the search results 132′. For example, a bookmarked search result 932-2 may embed the original query (e.g. “burritos”) in the header of the bookmarked search result 932-2 or may omit the header entirely. The bookmarked search results 932 may be displayed in any suitable order. For example, the search application 312 can be configured to list the bookmarked search results 932 according to most recent use, most selections by the user, or most recent update. The search application 312 may update the bookmarked search results 932 periodically or upon a user selection of a particular bookmarked search result 932.

In some implementations, one or more of the bookmarked search results 932 are collapsible and expandable. FIG. 9D illustrates an example of a user device 300 displaying bookmarked search results 932 in collapsed viewing mode and expanded viewing mode. As was described with respect to the displayed search results 132′, at least some bookmarked search results 932 can be presented in a collapsed viewing mode or in an expanded viewing mode 932-E. In the illustrated example, the Super Car and Trip Mate bookmarked search results 932-C are displayed in a collapsed viewing mode. In the collapsed viewing mode, a bookmarked search result may show limited content 934. For example, the limited content 934 displayed in the Super Car bookmarked search result 932-C is a proximity of the nearest black car (e.g., three minutes). Similarly, the limited content 934 displayed in the Trip Mate bookmarked search result 932-C indicates a number of links 904 corresponding to the query term “burritos” (e.g., seven links 904). A third bookmarked search result 932-E corresponding to the Flight-Finder software application is displayed in an expanded viewing mode 932-E. In the Flight-Finder bookmarked search result 932-E, the bookmarked search result 932-E displays the values that were used to parameterize the search result (e.g., departure airport, arrival airport, departure date, return date), as well as expanded content 906. In this example, the expanded content 906 includes the best fares on a collection of different airlines.

In these implementations, a collapsible/expandable bookmarked search result 932 can include a resize element 139. In this example, the Super Car and Trip Mate bookmarked search result 932-C include an expand resize element 139-E. In response to selection of an expand resize element 139-E, the search application 312 can display a collapsed bookmarked search result 932-C in an expanded viewing mode. For instance, if the user selects the expand resize element 139-E of the Super Car bookmarked search result 932-C, the search application 312 can render the bookmarked search result 932 in an expanded viewing mode (see e.g., FIG. 9C), whereby a map showing locations of available cars. In the example of FIG. 9D, the Flight Finder bookmarked search result 932-E includes a collapse resize element 139-C. In response to the user selection of the collapse resize element 139-C, the search application 312 renders the corresponding expanded bookmarked search result 932-E into a collapsed bookmarked search result 932-C. In doing so, the search application 312 may determine the limited content 904 which is displayed in the collapsed bookmarked search result 932-C. In the case of the Flight Finder bookmarked search result 932-E, when displayed in the collapsed viewing mode, the limited content 904 may indicate the departing and arrival airports, as well as a number of fares or the lowest fare (e.g., “flights starting from $327”).

In some implementations, bookmarked search results 932 may be displayed in a collapsed or expanded viewing mode based on a previously selected viewing mode. For example, if a user most recently selected resize element 139 in order to collapse the Super Car bookmarked search result 932-C, that search result 932-C may be displayed in a collapsed viewing mode the next time a user accesses bookmark SERP 910. Additionally, when a user bookmarks a displayed search result 132′, the currently selected viewing mode of the displayed search result 132′ may be stored in bookmarked result object 950 so that bookmarked search result 932 may be displayed in the same viewing mode. In other implementations, bookmarked search results 932 may be displayed in either of a collapsed or expanded viewing mode by default when the user accesses the bookmark SERP 910.

In some implementations, the search application 312 requests the expanded content 906 from a software application when a bookmarked search result 932 is rendered in the expanded viewing mode. For example, when a user selects an expand resize element 139-E, the search application 312 may issue a new request to the corresponding software application requesting the expanded content 906. Alternatively, the search application 312 may request the expanded content 906 from a software application upon activation of the bookmarked search result 932, even if the corresponding bookmarked search result 932 is initially displayed in a collapsed viewing mode. In these implementations, the search application 312 can render a collapsed bookmarked search result 932-C with a subset of the expanded content 906 (e.g., the limited content 904), thereby displaying the limited content 904 in the collapsed bookmarked search result 932-C. When the user opts to resize the collapsed bookmarked search result 932-C into an expanded bookmarked search result 932-E, the search application 912 can render the expanded bookmarked search result 932-C with the expanded content 906.

As previously discussed, when a user opts to bookmark a search result 132′, the search application 312 can store information relating to the search result 132′ so as to be able to render a bookmarked search result 932 when the user elects to view the bookmarked search results 932. FIG. 9E illustrates an example of a bookmarked result object 930. Upon receiving an instruction to bookmark a search result 132′, the search application 312 can generate a bookmarked result object 950 based on the result object 132 corresponding to the search result 132′ and any input values inputted by the user. In some implementations, the search application 312 can store the bookmark result objects 950 in the storage device 320 of the user device 300. Additionally or alternatively, the search application 312 can transmit the bookmark result objects 950 to the search engine 200. In these implementations, the search application 312 can request the bookmark result objects 950 corresponding to the user or user device 300 when the user elects to view his or her bookmarked search results 932 (e.g., activates the bookmarked search results 932).

In the example of FIG. 9E, a bookmark result object 950 can include a result object ID 952, display data 954, parameter data 956, layout data 958, and reference data 960. The result object ID 952 may have any suitable format. In some implementations, the result object ID 952 is a string of number, letters, and/or characters. Each time the user selects a new search result for bookmarking, the search application 312 can generate a new bookmark result object 950 and a new result object ID 952 corresponding to new bookmark result object 950.

The display data 954 may include data to be displayed in the bookmarked result object. The display data may include a title of the bookmarked search result 932, an icon of the software application that is displayed in the bookmarked search result 932, and/or any other suitable static data that may be displayed in the bookmarked search result 932. In some embodiments, a flag may be used to designate the different types of data and whether the display data is displayed when the bookmarked search result 932 is displayed in a collapsed viewing mode and/or in an expanded viewing mode.

The parameter data 956 can indicate zero or more values that were input by the user into the displayed search result 132′ that was selected for bookmarking. Each value may be paired with the parameter type to which the value corresponds. For instance, if the bookmark result object 132 corresponds to a flight reservation software application (e.g., “Flight Finder”), the parameter data 956 can include a first value indicating a departure airport (e.g., dep_airport=SFO), a second value indicating an arrival airport (e.g., arr_airport=DTW), a third value indicating a departure date (e.g., dep_year=2014, dep_mon=1, dep_date=2), and a fourth value corresponding to a return date (e.g., ret_year=2014, ret_mon=1, ret_date=15). When the user opts to bookmark a displayed search result 132′, the search application 312 can read in the values input by the user into the input elements and can store the values in the parameter data. To the extent the user has not entered in all of the values (e.g., no departure data or return date), those values corresponding to these parameters may be set to NULL. In this way, the user can enter these values into the bookmarked search result 932 after the search application 312 activates the bookmarked search result 932. For example, a user may wish to search for prices of different flight dates. The user may enter the airport codes but may leave the departure and return dates empty. When activated, the search application 312 can populate the airport codes in the bookmarked search result 932 but may leave the departure and return date input elements unpopulated. In this example, the user can enter different dates into the date input elements and select the bookmarked search result 932 to compare prices using different dates. Parameter values may be stored as Booleans, integers, decimals, ranges, strings, or any other suitable type of value.

In some implementations, context-specific parameter values, such as geolocation and time, may be excluded from the parameter data 956, unless explicitly entered in by the user. As such, the search application 312 can obtain the context-specific data (e.g., context parameters 104) when the user elects to activate the bookmarked search results 932. In these implementations, however, the parameter data 956 may define context-specific parameters that are to be obtained at activation time in order to request content from the software application corresponding to the bookmarked search result 932 and the bookmark result object 950. Additionally, parameter data 956 may include a value indicating whether the bookmarked search result 932 should be rendered in collapsed or expanded viewing mode. The parameter data 956 may also include the original search query 102.

Layout data 958 may include a layout file and/or a file path or memory address that indicates where a layout file corresponding to the bookmarked search result 932 may be read from. Additionally or alternatively the layout data 958 may include a layout ID corresponding to the layout file. The search application 312 may obtain the layout data 958 from the result object 132 that was used to render the displayed search result 132′ that the user selected for bookmarking. The layout data 958 may further include layout instructions defining the manner by which the search application can render bookmarked search result 932 in both collapsed and expanded modes. For example, the layout instructions may indicate which data fields should be displayed in a collapsed bookmarked search result 932-C and which data fields are displayed in an expanded bookmarked search result 932-E. In some examples, a bookmarked search result 932 may use rendered using different layout instructions than the displayed search result 132′ that the user selected for bookmarking. Furthermore, the layout data 958 may include bindings (e.g., input bindings and/or output bindings) for binding content to the layout file.

The reference data 960 may indicate instructions that the user device uses to access remote data sources (e.g., a server of a corresponding software application) in accordance with the stored parameter values in the parameter data 956 and/or one or more context parameters 104. For example, the reference data 960 may indicate a template for issuing an API call of a software application given one or more parameter types. The template can include fields that the search application 312 can parameterize with values stored in parameter data 956 or with context parameters 104. In the example of the Super Car application, the template may take the form of: “http://www.supercar.com/API?geo[lat],[long]&type=[car_type]”, where [lat] and [long] can be parameterized with a latitude and longitude of the user device 300 and [car_type] can be parameterized with one or more values indicating the type of car (e.g., 1=black car, 2=taxi, 1&2=black car and taxi). Thus, when the search application 312 activates a bookmarked search result 932 corresponding to the Super Car application, the search application 312 can obtain the car type preference of the user from the parameter data 956 (e.g., car_type=1, which indicates black car) stored in the bookmark result object 950 and a current geolocation of the user device 300 (e.g., lat=37.77, long=−122.45) from, for example, a GPS unit of the user device 300. The search application 312 can parameterize the API template with the obtained values. For example, using the example values above, the search application 312 can generate the following API call “http://www.supercar.com/API?geo=37.77,−122.45&type=1” in order to obtain availability data from the Super Car software application. The example API call may result in the website providing availability information (e.g. a JSON file) containing the GPS locations of available black cars in the vicinity of the provided geolocation. The reference data 960 may further have instructions for translating the received content into a value that the search application can bind to a layout file using, for example, a binding.

The search application 312 can receive the reference data 960 from the search engine 200 in the result object 132 corresponding to the displayed search result 132′ that the user selected for bookmarking. Alternatively, the search application 312 can request the reference data 960 from the search engine 200 when the user selects the displayed search result 132′ for bookmarking.

The bookmark result object 950 of FIG. 9E is provided for example and not intended to limit the scope of the disclosure. The bookmark result object 950 may store additional or alternative types of data. Other suitable data structures may be used in place of the bookmark result object 950.

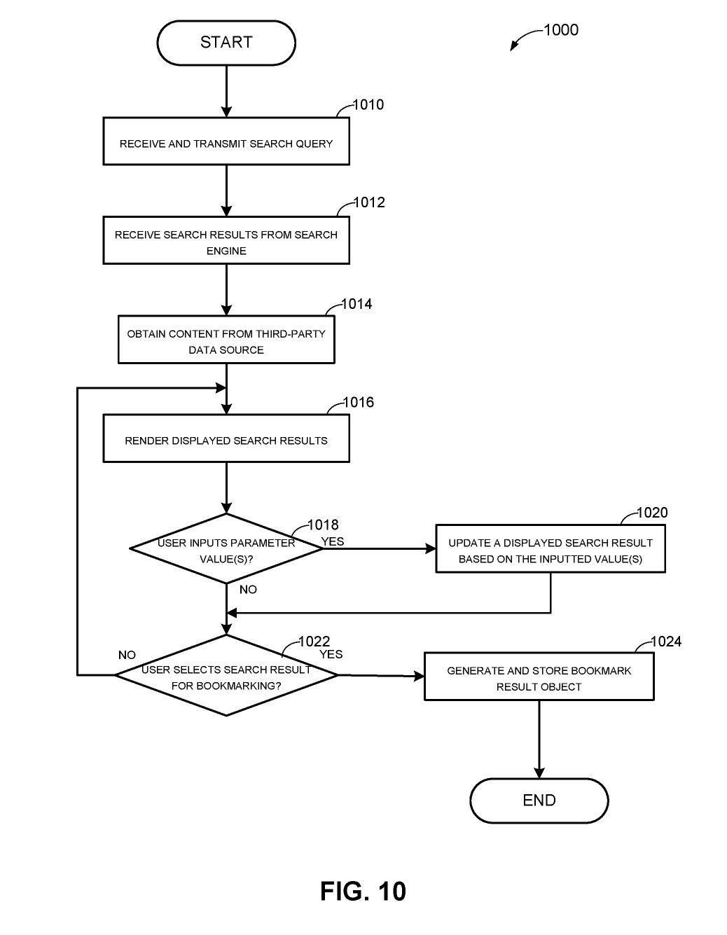

FIG. 10 illustrates an example set of operations of a method 1000 for bookmarking a search result 132′. The method 1000 is explained with respect to the search application, but may be performed by other suitable applications as well.

At operation 1010, the search application 312 receives a search query 102 from a user via a user interface of the user device 300 and transmits the search query 102 to a search engine 200. In some implementations, the search application 312 may obtain one or more context parameters 104 at query time and may transmit the context parameters 104 with the search query 102 to the search engine 200.

At operation 1012, the search application 312 receives the search results 130 from the search engine 200. The search results 130 may include one or more result objects 132. Each result object 132 may include data and instructions for rendering a displayed search result 132′. In some implementations, a result object 132 may further include content that is used to render a displayed search result 132′ (e.g., access mechanisms and data that is displayed in the search result). In other implementations, a result object 132 may include reference data (e.g., API calls) to obtain content that the search application 312 uses to render the displayed search result 132′. In these implementations, the search application 312 obtains content from third-party resources using the reference data contained in the result objects 132, as shown at operation 1014. For instance, the reference data may include API calls that can be transmitted to respective software applications. The search application 312 can issue the API calls. In response to the API call, each software application (e.g., a server of the software application) returns requested content.

At operation 1016, the search application 312 renders the displayed search results 132′. For each result object 132, the search application 312 may render a displayed search result 132′ using a layout file and the content corresponding to the result object. The search application 312 may utilize a binding to bind the content to the displayed search result. The layout file and the binding may be communicated in or with the result object 132 or may be stored at the user device 300.

At operation 1018, the search application 312 determines whether the user has input any values into the input elements in any of the displayed search results 132′. If so, the search application 312 updates the displayed search result 132′ based on the inputted value. For example, the search application 312 may display the inputted value in the corresponding input element 134. Furthermore, in some scenarios, the search application 312 may update the content used to render the displayed search result 132′. In such scenarios, the search application 312 can request updated content from a third party resource corresponding to the displayed search result 132′ based on the inputted values and the resource data (e.g., issue a new API call using the inputted values). At operation 1020, in response to receiving the updated content, the search application 312 may re-render the displayed search result 132′ using the updated content.

At operation 1022, the search application 312 determines whether the user has selected a displayed search result 132′ for bookmarking. For example, the user may select a bookmark selection element 902 displayed in one of the displayed search results 132′. Such a selection indicates that the user wishes to bookmark the displayed search result 132′.

When the user selects a displayed search result 132′ for bookmarking, the search application 312 can generate a new bookmark result object 950 corresponding to the displayed search result 132′ and can store the bookmark result object 950, as shown at operation 1024. In some implementations, the search application 312 generates a new bookmark result object 950 and a result object ID 952 for the new bookmark result object 950. The search application 312 can obtain any relevant display data 954 (e.g. icons, application name, etc.) from the result object 132 used to render the displayed search result 132′. The search application 312 can store any inputted values into the displayed search result in the parameter data 956 of the bookmark result object 950. Additionally, the search application 312 can obtain the layout data 958 from the result object 132 used to render the displayed search result 132′. The layout data 958 includes a layout file and binding, a layout ID, a filepath where the layout file and binding are stored, and/or a memory address indicating an address in the storage device 320 where the layout file and binding are stored. The search application 312 can also include reference data 960 (e.g., API call or template for generating API calls) in the bookmark result object 950. The search application 312 can obtain the reference data 960 from the result object 132 or can request the reference data 960 from the search engine 200. Once generated, the search application 312 can store the bookmark result object 950 in the storage device 320. Additionally or alternatively, the search application 312 can transmit the bookmark result object 950 to the search engine 200, which stores the bookmarked result objects 950 of the user.

The method of FIG. 10 is provided for example and not intended to limit the scope of the disclosure. The method may include additional or alternative operations not explicitly discussed above or shown in FIG. 10. Further, at any time after the search results 130 are rendered, the user can select a displayed search result 132′. In such a scenario, the search application 312 can launch an edition of the software application indicated by the search result 132′ to a state defined by an access mechanism of the displayed search result 132′.

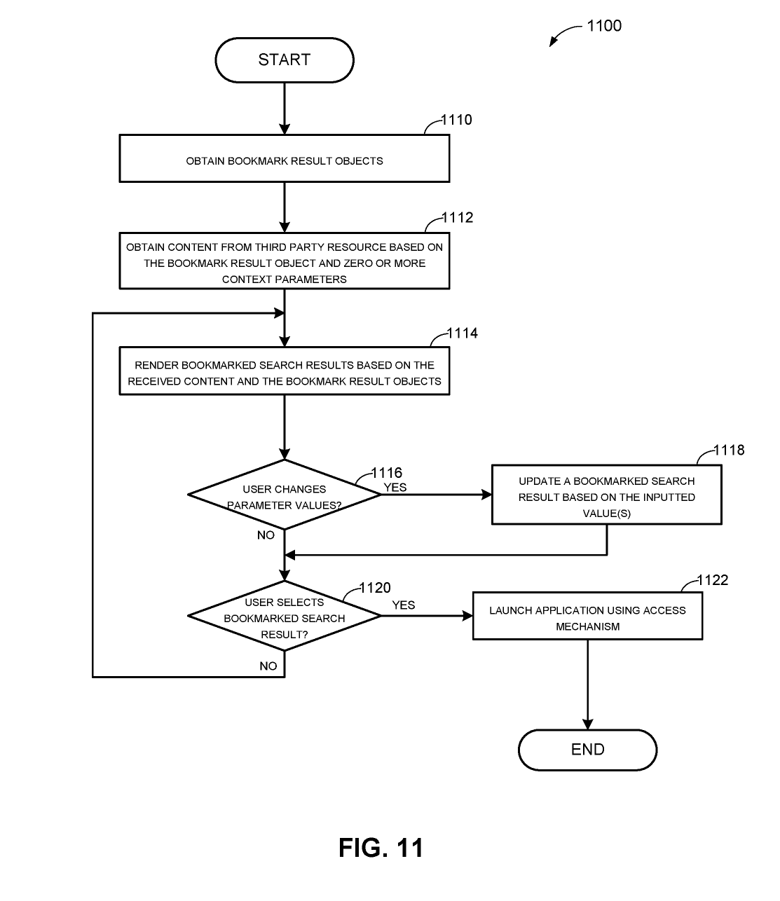

FIG. 11 illustrates an example set of operations of a method 1100 for activating and displaying bookmarked search results 932. The method 1100 is explained with respect to the search application, but may be performed by other suitable applications as well.

At operation 1110, the search application 312 obtains bookmark result objects 950. The search application 312 may obtain the bookmark result objects 950 in response to a user instruction to activate the bookmarked search results 932. For example, the user may swipe from the default SERP to the bookmark SERP 910. The search application 312 can retrieve the bookmark result objects 950 from the storage device 320 of the user device 300 or may request the bookmark result objects 950 from the search engine 200.

At operation 1112, for each bookmark result object 950, the search application 312 obtains content from a third party resource based on the bookmark result object 950 and zero or more context parameters 104. As discussed, the bookmark result object 950 can include reference data 960 that includes a template for generating an API call. The bookmark result object 950 can generate an API call using one or more values stored in the parameter data 956 of the bookmark result object 950 and/or one or more context parameters 104 (e.g., current geolocation and/or current time). The search application 312 can issue the generated API call. For example, the search application 312 can transmit an HTTP request to a third party resource (e.g., a server of a software application) using the generated API call (e.g., a URL). In response to the API call, the third party resource transmits the content to the user device 300. The search application 312 can retrieve content corresponding to each of the bookmark result objects 950 in this manner.

At operation 1114, the search application 312 can render the bookmarked search results 932 based on the received content and the bookmark result objects 950. For each result object 950, the search application 312 can render a bookmarked search result 932 based on the content and a layout file contained in or indicated by the layout data 958 of the bookmark result object 950. In some implementations, the search application 312 can bind the content to the layout file using a binding that is contained in or indicated by the layout data 958 of the bookmark result object 950. The search application 312 can then output the displayed search result 932 in the bookmark SERP 910.

At operation 1116, the search application 312 determines whether the user has changed any of the input values in any of the bookmarked search results 932. For example, if the bookmarked search result 932 corresponds to the Super Car software application (see e.g., FIGS. 9B and 9C), the user may wish to change the car type to include taxis in addition to black cars. If so, the search application 312 updates the bookmarked search result based on the inputted values, as shown at 1118. In such a scenario, the search application 312 may generate a new API call using the updated parameter value(s) and may issue the new API call to the corresponding third party resource. Continuing the Super Car software application, the search application 312 may generate the following API call “http://www.supercar.com/API?geo=37.77,−122.45&type=1&2”, such that the new API call requests availability data for taxis and black cars (e.g., type=1&2”). The third party application returns updated content and the search application re-renders the bookmarked search result 932 using the updated content. For example, in FIG. 9C, the bookmarked search result 932-1 may be updated to show locations of nearby black cars and taxis.

At operation 1120, the search application 312 determines whether the user has selected any of the bookmarked search results 932. If so, at operation 1122 the search application 312 launches an edition of the software application and sets the state of the launched edition according to an access mechanism associated with the selected bookmarked search result 932. In some implementations, the third-party resource provides the access mechanisms used to set the state of the edition of the application in the content provided in response to the API call.

The method of FIG. 11 is provided for example and not intended to limit the scope of the disclosure. The method may include additional or alternative operations not explicitly discussed above or shown in FIG. 11. Further, at any time after the bookmarked search results 932 are rendered, the user can unbookmark a bookmarked search result 932. For example, the user may select the bookmark selection element 902 to indicate that he or she wishes to remove the bookmarked search result 932 from the bookmark SERP 910. In response to such a selection, the search application 312 may remove the bookmarked search result 932 from the bookmark SERP 910 and may purge the bookmark result object 950 of the selected bookmarked search result 932 from memory.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at a processing device of a user device, a user instruction to display a set of bookmarked search results;
obtaining, by the processing device, one or more bookmark result objects in response to the user instruction, each bookmark result object respectively corresponding to a previously received search result that a user selected for bookmarking and including one or more parameter values previously entered by a user and reference data to obtain content from a third party resource; and
for each of the one or more bookmark result objects:
requesting, by the processing device, content from the third party resource using the reference data and the one or more parameter values;
receiving, by the processing device, the requested content from the third party resource;
rendering, by the processing device, a bookmarked search result based on the requested content; and
outputting, by the processing device, the bookmarked search result to a bookmark results page, the bookmark results page being displayed on a user interface of the user device.

2. The method of claim 1, further comprising:
receiving, by the processing device, a user selection of one of the bookmarked search results; and
launching, by the processing device, a native application edition of a software application indicated by the selected bookmarked search result using an application access mechanism associated with the selected bookmarked search result, wherein the application access mechanism instructs the processing device to set a state of the native application edition in accordance with the application access mechanism.

3. The method of claim 3, wherein the application access mechanism used to launch the native application is based on at least one of the one or more parameter values.

4. The method of claim 1, wherein the bookmarked search result includes one or more input elements that respectively receive values of a specified parameter type, whereby the user can adjust one or more parameter values used to request the content via the one or more input elements.

5. The method of claim 4, further comprising:
receiving, by the processing device, one or more values in the one or more input elements of the bookmarked search results from a user via the user interface; and
re-rendering, by the processing device, the bookmarked search result based on the one or more received values.

6. The method of claim 5, wherein re-rendering the bookmarked search result includes:
requesting updated content from the third-party resource based on the one or more received values and the reference data;
receiving the updated content from the third-party resource; and
rendering the bookmarked search result based on the updated content.

7. The method of claim 1, wherein the reference data of a bookmark result object includes an API template, the API template including one or more fields that are substituted with one or more of the one or more parameter values defined in the bookmark result object.

8. The method of claim 7, wherein requesting the content includes:
generating an API call based on the API template and the one or more parameter values; and
requesting the content from the third party resource using the API call.

9. The method of claim 1, wherein the method further includes:
receiving, by the processing device, a search query from a user via the user interface;
transmitting, by the processing device, the search query to the search engine;
receiving, by the processing device, search results from the search engine in response to the search query, the search results including one or more search result objects; and
for at least one of the search result objects:
rendering, by the processing device, a displayed search result based on the search result object, the displayed search result including one or more input elements that respectively receive input values from a user via the user interface;
outputting, by the processing device, the displayed search result to a search engine results page;
receiving, by the processing device, one or more input values in the one or more input elements via the user interface;
receiving, by the processing device, an instruction to bookmark the displayed search result;
generating, by the processing device, a new bookmark result object based on the search result object and the one or more received input values; and
storing, by the processing device, the new bookmark result object with the other bookmark result objects.

10. The method of claim 9, wherein storing the new bookmark result object includes storing the bookmark result object in a storage device of the user device.

11. A user device comprising:
a user interface;
a storage device that stores a plurality of bookmark result objects, each bookmark result object respectively corresponding to a previously received search result that a user selected for bookmarking and including reference data to obtain content from a third party resource;
a network interface device; and
a processing device in communication with the user interface, the storage device, and the network interface device, the processing device executing computer-readable instructions that when executed cause the processing device to:
receive a user instruction to display a set of bookmarked search results;
retrieve one or more of the bookmark result objects in response to the user instruction, wherein at least one of the one or more bookmark result objects include one or more parameter values previously entered by a user; and
for each of the at least one of the one or more bookmark result objects:
request content from the third party resource using the reference data and the one or more parameter values;
receive the requested content from the third party resource;
render a bookmarked search result based on the requested content; and
output the bookmarked search result to a bookmark results page, the bookmark results page being displayed on a user interface of the user device.

12. The user device of claim 11, wherein the computer readable instructions further cause the processing device to:
receive a user selection of one of the bookmarked search results; and
launch a native application edition of a software application indicated by the selected bookmarked search result using an application access mechanism associated with the selected bookmarked search result, wherein the application access mechanism instructs the processing device to set a state of the native application edition in accordance with the application access mechanism.

13. The user device of claim 13, wherein the application access mechanism used to launch the native application is based on at least one of the one or more parameter values.

14. The user device of claim 11, wherein the bookmarked search result includes one or more input elements that respectively receive values of a specified parameter type, whereby the user can adjust one or more parameter values used to request the content via the one or more input elements.

15. The user device of claim 14, wherein the computer readable instructions further cause the processing device to:
receive one or more values in the one or more input elements of the bookmarked search results from a user via the user interface; and
re-render the bookmarked search result based on the one or more received values.

16. The user device of claim 15, wherein re-rendering the bookmarked search result includes:
requesting updated content from the third-party resource based on the one or more received values and the reference data;
receiving the updated content from the third-party resource; and
rendering the bookmarked search result based on the updated content.

17. The user device of claim 11, wherein the reference data of a bookmark result object includes an API template, the API template including one or more fields that are substituted with one or more of the one or more parameter values defined in the bookmark result object.

18. The user device of claim 17, wherein requesting the content includes:
generating an API call based on the API template and the one or more parameter values; and
requesting the content from the third party resource using the API call.

19. The user device of claim 11, wherein the computer readable instructions further cause the processing device to:
receive a search query from a user via the user interface;
transmit the search query to the search engine;
receive search results from the search engine in response to the search query, the search results including one or more search result objects; and
for at least one of the search result objects:
render a displayed search result based on the search result object, the displayed search result including one or more input elements that respectively receive input values from a user via the user interface;
outputting, by the processing device, the displayed search result to a search engine results page;
receiving, by the processing device, one or more input values in the one or more input elements via the user interface;
receiving, by the processing device, an instruction to bookmark the displayed search result;
generating, by the processing device, a new bookmark result object based on the search result object and the one or more received input values; and
storing, by the processing device, the new bookmark result object with the other bookmark result objects.
